(19) United States
(12) Patent Application Publication
(10) Pub. No.: US 2006/0238684 A1
(43) Pub. Date: Oct. 26, 2006

(54) Liquid crystal panel and liquid crystal display apparatus

(75) Inventors: Yoshiyuki Kiya, Ibaraki (JP); Hiroyuki Yoshimi, Ibaraki (JP); Nao Murakami, Ibaraki (JP); Kentarou Takeda, Ibaraki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki (JP)

(21) Appl. No.: 11/407,926

(22) Filed: Apr. 21, 2006

(30) Foreign Application Priority Data
Apr. 25, 2005 (JP) 2005-126487
Jan. 6, 2006 (JP) 2006-001045

(51) Int. Cl. G02F 1/1335

(52) U.S. Cl. 349/118

(57) ABSTRACT

There is provided a liquid crystal panel and a liquid crystal display apparatus each allowing excellent viewing angle compensation and having excellent contrast and small color shift in an oblique direction. The liquid crystal panel of the present invention includes: a first polarizer; a first cellulose-based film; an optical compensation layer having an Nz coefficient represented by an equation (1) of 2≦Nz≦20; a liquid crystal cell; a second cellulose-based film; and a second polarizer in the order given from a backlight side to a viewer side, in which: the first cellulose-based film has a thickness direction retardation (Rth) represented by an equation (2) of 10 nm or less; and the second cellulose-based film has a thickness direction retardation (Rth) represented by the equation (2) of 10 nm or less.
Nz=(nx−nz)/(nx−ny) (1)
Rth=(nx−nz)×d (2)

### BACKGROUND OF THE INVENTION

1. Field of the Invention

The present invention relates to a liquid crystal panel and a liquid crystal display apparatus. The present invention more specifically relates to a liquid crystal panel and a liquid crystal display apparatus each allowing excellent viewing angle compensation and having excellent contrast in an oblique direction and small color shift.

2. Description of the Related Art

FIG. 7A shows a schematic sectional view of a typical conventional liquid crystal display apparatus, and FIG. 7B shows a schematic sectional view of a liquid crystal cell to be used for the liquid crystal display apparatus. The liquid crystal display apparatus 900 is provided with: a liquid crystal cell 910; retardation plates 920 and 920′ arranged on outer sides of the liquid crystal cell 910; and polarizing plates 930 and 930′ arranged on outer sides of the respective retardation plates 920 and 920′. Typically, the polarizing plates 930 and 930′ are arranged such that respective absorption axes are perpendicular to each other. The liquid crystal cell 910 includes: a pair of substrates 911 and 911′; and a liquid crystal layer 912 as a display medium arranged between the substrates. One substrate 911 is provided with: a switching element (typically, TFT) for controlling electrooptic properties of liquid crystals; and a scanning line for providing a gate signal to the switching element and a signal line for providing a source signal thereto (the element and the lines not shown). The other substrate 911′ is provided with: color layers 913R, 913G, and 913B forming a color filter; and a light shielding layer (black matrix layer) 914. A distance (cell gap) between the substrates 911 and 911′ is controlled by a spacer (not shown).

The retardation plates are used for optical compensation of the liquid crystal display apparatus. In order to obtain optimum optical compensation (improvement in viewing angle properties, color shift, and contrast, for example), various attempts have been made at optimization of optical properties of the retardation plates and/or at arrangement of the retardation plates in the liquid crystal display apparatus. As shown in FIG. 7A, the retardation plate are each conventionally arranged between the liquid crystal cell 910, and the polarizing plates 930 and 930′ (see JP 11-95208A, for example) In order to obtain optimum optical compensation with such a structure, retardation plates described in JP 11-95208 A to be arranged on both sides of a liquid crystal cell each have a thickness of 140 μm. However, in use of the conventional retardation plates for a liquid crystal display apparatus in conventional arrangement often provides reduced contrast in an oblique direction and often provides increased color shift. Meanwhile, further improvement in screen evenness and in display quality has been demanded for a recent high-resolution and high-performance liquid crystal display apparatus. In consideration of such a demand, the reduction in contrast in an oblique direction and the increase in color shift are very important problems.

As described above, a liquid crystal display apparatus which can satisfy the demand for excellent display quality has been desired strongly.

### SUMMARY OF THE INVENTION

The present invention has been made in view of solving the conventional problems described above, and an object of the present invention is therefore to provide a liquid crystal panel and a liquid crystal display apparatus each allowing excellent viewing angle compensation and having excellent contrast and small color shift in an oblique direction.

The liquid crystal panel of the present invention includes: a first polarizer; a first cellulose-based film; an optical compensation layer having an Nz coefficient represented by an equation (1) of 2≦Nz≦20; a liquid crystal cell; a second cellulose-based film; and a second polarizer in the order given from a backlight side to a viewer side, in which: the first cellulose-based film has a thickness direction retardation (Rth) represented by an equation (2) of 10 nm or less; and the second cellulose-based film has a thickness direction retardation (Rth) represented by the equation (2) of 10 nm or less:
Nz=(nx−nz)/(nx−ny) (1)
Rth=(nx−nz)×d (2)

In a preferred embodiment, the above-described first cellulose-based film has a thickness direction retardation (Rth) of 6 nm or less.

In a preferred embodiment, the above-described first cellulose-based film includes an aliphatic acid-substituted cellulose-based polymer.

In a preferred embodiment, the above-described aliphatic acid-substituted cellulose-based polymer has a degree of acetic acid substitution of 1.8 to 2.7.

In a preferred embodiment, the above-described aliphatic acid-substituted cellulose-based polymer has a degree of propionic acid substitution of 0.1 to 1.

In a preferred embodiment, the above-described first cellulose-based film includes at least one plasticizer selected from the group consisting of dibutyl phthalate, p-toluenesulfonanilide, and acetyl triethyl citrate.

In a preferred embodiment, a content of the above-described plasticizer is 40 parts by weight or less with respect to 100 parts by weight of the above-described aliphatic acid-substituted cellulose-based polymer.

In a preferred embodiment, the above-described second cellulose-based film has a thickness direction retardation (Rth) of 6 nm or less.

In a preferred embodiment, the above-described second cellulose-based film includes an aliphatic acid-substituted cellulose-based polymer.

In a preferred embodiment, the above-described aliphatic acid-substituted cellulose-based polymer has a degree of acetic acid substitution of 1.8 to 2.7.

In a preferred embodiment, the above-described aliphatic acid-substituted cellulose-based polymer has a degree of propionic acid substitution of 0.1 to 1.

In a preferred embodiment, the above-described second cellulose-based film includes at least one plasticizer selected from the group consisting of dibutyl phthalate, p-toluenesulfonanilide, and acetyl triethyl citrate.

In a preferred embodiment, a content of the above-described plasticizer is 40 parts by weight or less with respect to 100 parts by weight of the above-described aliphatic acid-substituted cellulose-based polymer.

In a preferred embodiment, the above-described optical compensation layer has a refractive index profile of nx>ny>nz.

In a preferred embodiment, the above-described optical compensation layer is formed of at least one non-liquid crystalline material selected from the group consisting of polyamide, polyimide, polyester, polyetherketone, polyamideimide, and polyesterimide.

In a preferred embodiment, a slow axis of the above-described optical compensation layer and an absorption axis of the above-described first polarizer are substantially perpendicular to each other.

In a preferred embodiment, the above-described liquid crystal cell is of one of VA mode and OCB mode.

Another aspect of the present invention provides a liquid crystal display apparatus. The liquid crystal display apparatus of the present invention includes the liquid crystal panel.

The present invention can provide a liquid crystal panel and a liquid crystal display apparatus each allowing excellent viewing angle compensation and having excellent contrast in an oblique direction and small color shift. Such an effect can be obtained significantly with a liquid crystal panel including a first polarizer, a specific first cellulose-based film having a small thickness direction retardation (Rth), a specific optical compensation layer, a liquid crystal cell, a specific second cellulose-based film having a small thickness direction retardation (Rth), and a second polarizer in the order give from a backlight side to a viewer side.

### BRIEF DESCRIPTION OF THE DRAWINGS

In the accompanying drawings;

FIG. 1 is a schematic sectional view of a liquid crystal panel according to a preferred embodiment of the present invention;

FIG. 2 is a schematic sectional view explaining an alignment state of liquid crystal molecules of a liquid crystal layer in the case where a liquid crystal display apparatus of the present invention employs a liquid crystal cell of VA mode;

FIG. 3 is a schematic sectional view explaining an alignment state of liquid crystal molecules of a liquid crystal layer in the case where a liquid crystal display apparatus of the present invention employs a liquid crystal cell of OCB mode;

FIG. 4 is a schematic diagram explaining an azimuth angle and a polar angle in color shift measurement;

FIG. 5 is an XY chromaticity diagram showing the result of color shift measurement of liquid crystal panels of Example 1 and Comparative Example 1 of the present invention at an azimuth angle of 45° and a polar angle varying from 0 to 70°;

FIG. 6 is an XY chromaticity diagram showing the result of color shift measurement of liquid crystal panels of Example 1 and Comparative Example 1 of the present invention at a polar angle of 60° and an azimuth angle varying from 0 to 360°; and

FIG. 7A is a schematic sectional view of a typical conventional liquid crystal display apparatus, and FIG. 7B is a schematic sectional view of a liquid crystal cell to be used for the liquid crystal display apparatus.

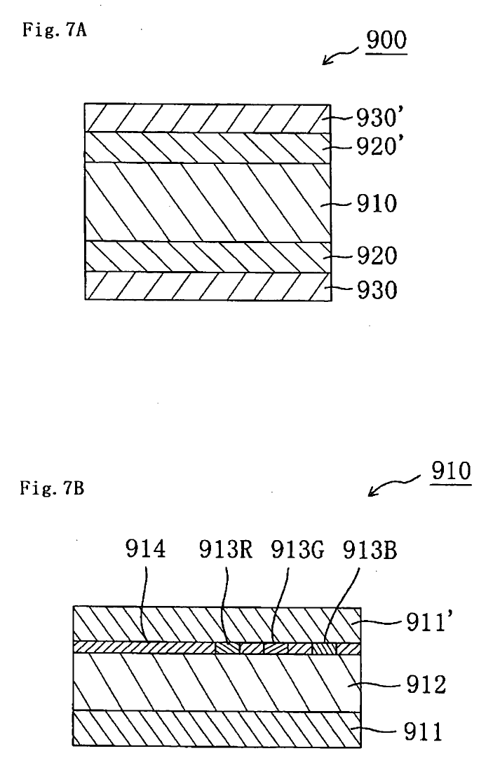

### DESCRIPTION OF THE PREFERRED EMBODIMENTS

A. Structure of Liquid Crystal Panel and Liquid Crystal Display Apparatus Including the Same

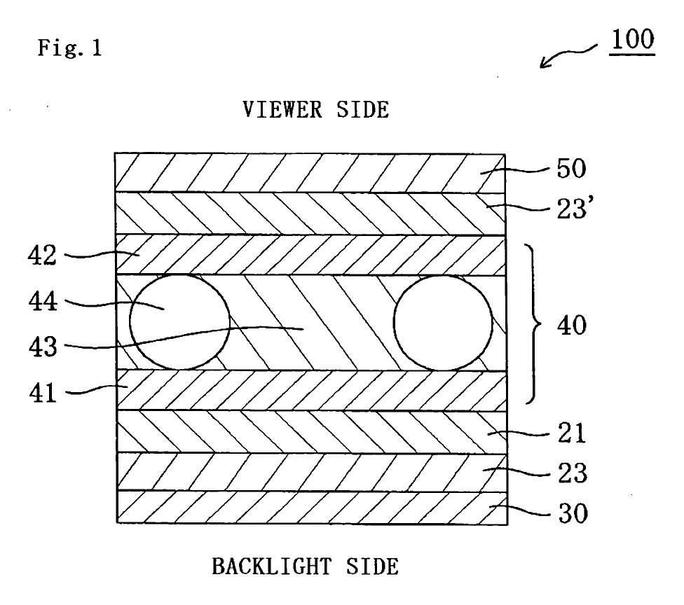

FIG. 1 is a schematic sectional view explaining a preferred embodiment of a liquid crystal panel 100 of the present invention. The liquid crystal panel 100 is provided with: a first polarizer 30; a first cellulose-based film 23; an optical compensation layer 21; a liquid crystal cell 40; a second cellulose-based film 23′; and a second polarizer 50 in the order given from a backlight side to a viewer side. That is, in the present invention, the liquid crystal panel includes a first polarizer, a specific first cellulose-based film having a small thickness direction retardation (Rth), a specific optical compensation layer, a liquid crystal cell, a specific second cellulose-based film having a small thickness direction retardation (Rth), and a second polarizer in the order give from a backlight side to a viewer side. Such a structure can provide a liquid crystal panel and a liquid crystal display apparatus each allowing excellent viewing angle compensation and having excellent contrast in an oblique direction and small color shift.

A slow axis of the optical compensation layer 21 and an absorption axis of the first polarizer 30 may be parallel or perpendicular to each other. Preferably, the slow axis of the optical compensation layer 21 and the absorption axis of the first polarizer 30 are substantially perpendicular to each other.

The liquid crystal cell 40 includes: a pair of glass substrates 41 and 42; and a liquid crystal layer 43 as a display medium arranged between the substrates. One substrate (active matrix substrate) 41 is provided with: a switching element (typically, TFT) for controlling electrooptic properties of liquid crystals; and a scanning line for providing a gate signal to the switching element and a signal line for providing a source signal thereto (the lines not shown). The other glass substrate (color filter substrate) 42 is provided with a color filter (now shown). Note that the color filter may be provided in the active matrix substrate 41 as well. A distance (cell gap) between the substrates 41 and 42 is controlled by a spacer 44. An aligned film (not shown) formed of polyimide, for example, is provided on a side of each of the substrates 41 and 42 in contact with the liquid crystal layer 43.

Any appropriate drive mode can be employed for drive mode of the liquid crystal cell 40 as long as effects of the present invention can be obtained. Specific examples of the drive mode include STN (Super Twisted Nematic) mode, TN (Twisted Nematic) mode, IPS (In-Plane Switching) mode, VA (Vertical Aligned) mode, OCB (Optically Aligned Birefringence) mode, HAN (Hybrid Aligned Nematic) mode, and ASM (Axially Symmetric Aligned Microcell) mode. The VA mode and the OCB mode are preferred because of their remarkable improvements in color shifts.

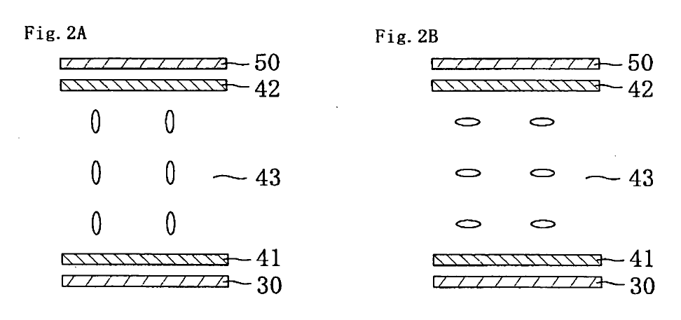

FIGS. 2A and 2B are each a schematic sectional view explaining an alignment state of liquid crystal molecules in VA mode. As shown in FIG. 2A, the liquid crystal molecules are aligned vertically to surfaces of the substrates 41 and 42 under no voltage application. Such vertical alignment may be realized by arranging nematic liquid crystals having negative dielectric anisotropy between substrates each having formed thereon a vertically aligned film (not shown). Light enters from a surface of one substrate 41 in such a state, and linear polarized light allowed to pass through the first polarizer 30 and to enter the liquid crystal layer 43 advances along long axes of vertically aligned liquid crystal molecules. No birefringence generates in a long axis direction of the liquid crystal molecules such that incident light advances without changing a polarization direction and is absorbed by the second polarizer 50 having a polarization axis perpendicular to the first polarizer 30. In this way, dark display is obtained under no voltage application (normally black mode). As shown in FIG. 2B, long axes of the liquid crystal molecules align parallel to the surfaces of the substrates under voltage application between electrodes. The liquid crystal molecules exhibit birefringence with respect to linear polarized light entering the liquid crystal layer 43 in such a state, and a polarization state of incident light varies depending on inclination of the liquid crystal molecules. Light allowed to pass through the liquid crystal layer under application of a predetermined maximum voltage rotates its polarization direction by 90°, for example, into linear polarized light and passes through the second polarizer 50, to thereby provide light display. Return to a state under no voltage application provides dark display again by alignment control force. The inclination of the liquid crystal molecules is controlled by varying an application voltage. Therefore, an intensity of transmitted light from the second polarizer 50 may change, to thereby provide gradient display.

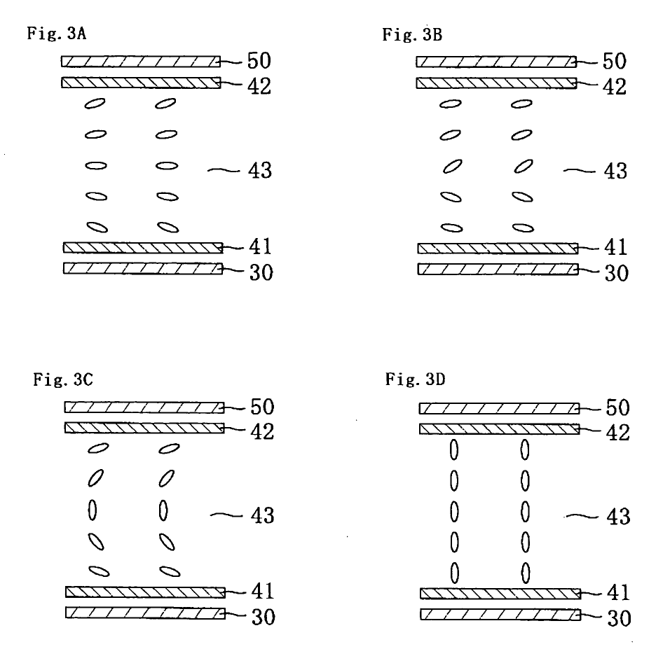

FIGS. 3A to 3D are each a schematic sectional view explaining an alignment state of liquid crystal molecules in OCB mode. The OCB mode refers to drive mode in which the liquid crystal layer 43 is formed of so-called bend alignment. As shown in FIG. 3C, the bend alignment refers to an alignment state in which: nematic liquid crystal molecules are aligned at a substantially parallel angle (alignment angle) in a vicinity of a substrate; the alignment angle forms a vertical angle with respect to a plane of the substrate toward the center of the liquid crystal layer; the alignment changes progressively and continuously to be parallel to the opposing substrate surface away from the center of the liquid crystal layer; and no twisted structure exists throughout the liquid crystal layer. Such bend alignment is formed as described below. As shown in FIG. 3A, the liquid crystal molecules have substantially homogenous alignment in a state in the absence of an electric field (initial state). However, the liquid crystal molecules each have a pretilt angle, and a pretilt angle in the vicinity of the substrate differs from a pretilt angle in the vicinity of the opposing substrate. Upon application of a predetermined bias voltage (typically, 1.5 V to 1.9 V) (under low voltage application), the liquid crystal molecules undergo a spray alignment as shown in FIG. 3B and transfer to a bend alignment as shown in FIG. 3C. Upon application of a display voltage (typically, 5 V to 7 V) (under high voltage application), the liquid crystal molecules in a bend alignment state align substantially vertically to the surface of the substrate as shown in FIG. 3D. In normally white display mode, light allowed to pass through the first polarizer 30 and to enter the liquid crystal layer in a state as shown in FIG. 3D under high voltage application advances without changing a polarization direction and is absorbed by the second polarizer 50, to thereby provide dark display. Reduction in display voltage returns the liquid crystal molecules into bend alignment by alignment control force of rubbing treatment, to thereby provide light display again. The inclination of the liquid crystal molecules is controlled by varying a display voltage. Therefore, an intensity of transmitted light from the polarizer may change, to thereby provide gradient display. A liquid crystal display apparatus provided with a liquid crystal cell of OCB mode allows very high speed switching of phase transfer from spray alignment state to bend alignment state, and thus has a characteristic of better movie display properties than those of a liquid crystal display apparatus provided with a liquid crystal cell of other drive mode such as TN mode or IPS mode.

The display mode of the liquid crystal cell of OCB mode may be: normally white mode which exhibits a dark state (black display) under high-voltage application; or normally black mode which exhibits a bright state (white display) under high voltage application.

A cell gap of the liquid crystal cell of OCB mode is preferably 2 μm to 10 mm, more preferably 3 μm to 9 μm, and particularly preferably 4 μm to 8 μm. A cell gap within the above ranges can reduce a response time and provide favorable display properties.

The nematic liquid crystals to be used for the liquid crystal cell of OCB mode preferably have positive dielectric anisotropy. Specific examples of the nematic liquid crystals having positive dielectric anisotropy include those descried in JP 09-176645 A. Further, commercially available nematic liquid crystals may be used as they are. Examples of the commercially available nematic liquid crystals include “ZLI-4535” and “ZLI-1132” (tradename, manufactured by Merck Ltd., Japan). A difference between the ordinary index of refraction (no) and extraordinary index of refraction (ne) of the nematic liquid crystals, that is, a birefringence (Δn_{LC}) may appropriately be selected in accordance with response speed and transmittance of the liquid crystals, and the like. However, the birefringence is preferably 0.05 to 0.30, more preferably 0.10 to 0.30, and furthermore preferably 0.12 to 0.30. Such nematic liquid crystals each have a pretilt angle of preferably 1° to 10°, more preferably 2° to 8°, and particularly preferably 3′ to 6°. A pretilt angle within above ranges can reduce response time and provide favorable display properties.

The liquid crystal panel as described above may suitably be used for a liquid crystal display apparatus such as a personal computer, a liquid crystal television, a cellular phone, a portable digital assistance (PDA), or a projector.

B. Polarizer

The polarizers (first polarizer 30, second polarizer 50) of the present invention are each formed of a polyvinyl alcohol-based resin. The polarizers of the present invention are each preferably prepared by coloring a polyalcohol-based resin film with a dichromatic substance (typically, iodine or dichromatic dye) and uniaxially stretching the colored resin. A polyvinylalcohol-based resin used for forming the polyvinyl alcohol-based resin film has a degree of polymerization of preferably 100 to 5,000, and more preferably 1,400 to 4,000. The polyvinyl alcohol-based resin film used for forming a polarizer may be formed through any appropriate method (such as a flow casting method in which a solution prepared by dissolving a resin in water or an organic solvent is used for film formation through flow casting, a casting method, or an extrusion method). A thickness of the polarizer may appropriately be set in accordance with the purpose or application of a liquid crystal display apparatus or image display apparatus to be used, but is preferably 5 to 80 μm.

A method of producing a polarizer involves subjecting the polyvinyl alcohol-based resin film to a production process including a coloring step, a crosslinking step, a stretching step, a washing step, and a drying step. In each of the steps except the drying step, each treatment is performed by immersing the polyvinyl alcohol-based resin film in a bath containing a solution to be used for each of the steps. The order, number, and the implementation or omission of treatments in the coloring step, the crosslinking step, the stretching step, the washing step, and the drying step may appropriately be set in accordance with the purpose, materials to be used, conditions, and the like. For example, several treatments may be performed at the same time in one step, or specific treatments may be omitted. To be specific, the stretching treatment, for example, may be performed after the coloring treatment, before the coloring treatment, or during the coloring treatment and the crosslinking treatment. Further, the crosslinking treatment is preferably performed before or after the stretching treatment, for example. Further, the washing treatment may be performed after each treatment, or performed after specific treatments. Particularly preferably, the coloring step, the crosslinking step, the stretching step, the washing step, and the drying step are preferably performed in the order given. Further, a swelling step may be performed before the coloring step as a preferred mode.

(Swelling Step)

The swelling step refers to a step of swelling the polyvinyl alcohol-based resin film. Typically, the swelling step is performed by immersing the polyvinyl alcohol-based resin film in a treatment bath (swelling bath) filled with water. This treatment allows washing of contamination or an antiblocking agent on a surface of the polyvinyl alcohol-based resin film, and prevention of unevenness such as uneven coloring by swelling the polyvinyl alcohol-based resin film. Glycerin or potassium iodide may appropriately be added to the swelling bath. A temperature of the swelling bath is preferably 20 to 60° C., and more preferably 20 to 50° C. An immersion time in the swelling bath is preferably 0.1 to 10 minutes, and more preferably 1 to 7 minutes. Note that the polyvinyl alcohol-based resin film may be swelled in the coloring step as described below, and thus the swelling step may be omitted.

In pulling out of the film from the swelling bath, any appropriate liquid dripping preventing rolls such as pinch rolls may be used as required for preventing liquid dripping, or excess water may be removed through a method of removing a liquid by an air knife or the like.

(Coloring Step)

The coloring step is typically performed by immersing (also referred to as adsorbing or contacting) the polyvinyl alcohol-based resin film in a treatment bath (coloring bath) containing a dichromatic substance such as iodine. Water is generally used as a solvent to be used for a solution of the coloring bath, but an appropriate amount of an organic solvent having compatibility with water may also be added. The dichromatic substance is used in a ratio of preferably 0.01 to 10 parts by weight, more preferably 0.02 to 7 parts by weight, and more preferably 0.025 to 5 parts by weight with respect to 100 parts by weight of the solvent.

An arbitrary and appropriate substance suitable for the present invention can be used as the dichromatic substance, and examples of the substance includes iodine and an organic dye. Examples of the organic dye include Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, and Fast Black.

In the coloring step, one type of dichromatic substance may be used, or two or more types thereof may be used in combination. In the case where an organic dye is used, two or more types of dichromatic substances are preferably used for neutralization of a visible light region, for example. Specific examples of the combination include: Congo Red and Supra Blue G; Supra Orange GL and Direct Sky Blue; and Direct Sky Blue and Fast Black.

In the case where iodine is used as a dichromatic substance, the solution of the coloring bath preferably further contains an auxiliary agent such as an iodide for improving coloring efficiency. Specific examples of the iodide include potassium iodide, lithium iodide, sodium iodide, zinc iodide, aluminum iodide, lead iodide, copper iodide, barium iodide, calcium iodide, tin iodide, and titanium iodide. Of those, potassium iodide is preferred. The auxiliary agent is used in a ratio of preferably 0.02 to 20 parts by weight, more preferably 0.01 to 10 parts by weight, and furthermore preferably 0.1 to 5 parts by weight with respect to 100 parts by weight of the solvent. A ratio (weight ratio) of iodine to auxiliary agent (preferably, potassium iodide) is preferably 1:5 to 1:100, more preferably 1:6 to 1:80, and furthermore preferably 1:7 to 1:70.

A temperature of the coloring bath is preferably 5 to 70° C., more preferably 5 to 42° C., and furthermore preferably 10 to 35° C. An immersion time in the coloring bath is preferably 1 to 20 minutes, and more preferably 2 to 10 minutes.

In the coloring step, the film may be stretched in the coloring bath. A cumulative total stretch ratio at this time is preferably 1.1 to 4.0 times.

The coloring treatment in the coloring step may employ a method involving applying or spraying an aqueous solution containing a dichromatic substance to the polyvinyl alcohol-based resin film, in addition to the method involving immersing the resin film in the coloring bath as described above. Further, the dichromatic substance may be mixed into the film during film formation in the previous step. In this case, the previous step and the coloring step are performed at the same time.

In pulling out of the film from the coloring bath, any appropriate liquid dripping preventing rolls such as pinch rolls may be used as required for preventing liquid dripping, or excess water may be removed through a method of removing a liquid with an air knife or the like.

(Crosslinking Step)

The crosslinking step is typically performed by immersing the polyvinyl alcohol-based resin film subjected to the coloring treatment in a treatment bath (crosslinking bath) containing a crosslinking agent. Any appropriate crosslinking agent may be used as the crosslinking agent. Specific examples of the crosslinking agent include a boron compound such as boric acid or borax, glyoxal, and glutaraldehyde. One type of crosslinking agent may be used alone or the crosslinking agents may be used in combination. In the case where two or more types thereof are used in combination, for example, a combination of boric acid and borax is preferred. A ratio (molar ratio) of the combination is preferably 4:6 to 9:1, more preferably 5.5:4.5 to 7:3, and furthermore preferably 5.5:4.5 to 6.5:3.5.

Water is generally used as a solvent to be used for a solution of the crosslinking bath, but an appropriate amount of an organic solvent having compatibility with water may also be added. The crosslinking agent is typically used in a ratio of 1 to 10 parts by weight with respect to 100 parts by weight of the solvent. A concentration of the crosslinking agent of less than 1 part by weight often provides insufficient optical properties. A concentration of the crosslinking agent of more than 10 parts by weight increases stretching force on the film during stretching and may shrink a polarizing plate to be obtained, for example.

The solution of the crosslinking bath preferably further contains an auxiliary agent containing potassium iodide as an essential component for providing even properties in the plane of the film. A concentration of the auxiliary agent is preferably 0.05 to 15 wt %, more preferably 0.1 to 10 wt %, and furthermore preferably 0.5 to 8 wt %. Examples of the auxiliary agent except potassium iodide include lithium iodide, sodium iodide, zinc iodide, aluminum iodide, lead iodide, copper iodide, barium iodide, calcium iodide, tin iodide, and titanium iodide. One type of auxiliary agent may be used, or two or more types thereof may be used in combination.

A temperature of the crosslinking bath is preferably 20 to 70° C., and more preferably 40 to 60° C. An immersion time in the crosslinking bath is preferably 1 second to 15 minutes, and more preferably 5 seconds to 10 minutes.

Similar to the coloring step, the crosslinking step may employ a method involving applying or spraying a crosslinking agent-containing solution to the film. In the crosslinking step, the film may be stretched in the crosslinking bath. A cumulative total stretch ratio at this time is preferably 1.1 to 4.0 times.

In pulling out of the film from the crosslinking bath, any appropriate liquid dripping preventing rolls such as pinch rolls may be used as required for preventing liquid dripping, or excess water may be removed through a method of removing a liquid with an air knife or the like.

(Stretching Step)

The stretching step refers to a step of stretching the polyvinyl alcohol-based resin film. The stretching step may be performed at any stage of the production process of the polarizer as described above. To be specific, the stretching step may be performed after the coloring treatment, before the coloring treatment, during the swelling treatment, coloring treatment, or crosslinking treatment, or after the crosslinking treatment.

A cumulative total stretch ratio of the polyvinyl alcohol-based resin film is preferably 2 to 7 times, more preferably 5 to 7 times, and furthermore preferably 5 to 6.5 times. A cumulative total stretch ratio of less than 2 times may cause difficulties in obtaining a polarizing plate with a high degree of polarization. A cumulative total stretch ratio of more than 7 times may cause the polyvinyl alcohol-based resin film (polarizer) to be liable to tear. The film after stretching has a thickness of preferably 3 to 75 μm, and more preferably 5 to 50 μm.

Any appropriate method may be employed as a specific stretching method. Examples thereof include: a wet stretching method in which the polyvinyl alcohol-based resin film is stretched in a hot aqueous solution; and a dry stretching method in which the polyvinyl alcohol-based resin film containing water is stretched in air. In the case where the wet stretching method is employed, the polyvinyl alcohol-based resin film is stretched to a predetermined ratio in a treatment bath (stretching bath).

A solution of the stretching bath to be used is preferably a solution containing potassium iodide as an essential component in a solvent such as water or an organic solvent (ethanol, for example) The solution may contain one type or two or more types of compounds selected from various metal salts, a boron or zinc compound, lithium iodide, sodium iodide, zinc iodide, aluminum iodide, lead iodide, copper iodide, barium iodide, calcium iodide, tin iodide, and titanium iodide, in addition to potassium iodide. Of those, boric acid is preferably contained. A concentration of potassium iodide is preferably 0.05 to 15 wt %, more preferably 0.1 to 10 wt %, and furthermore preferably 0.5 to 8 wt %. In the case where boric acid and potassium iodide are used in combination, a ratio (weight ratio) of the combination is preferably 1:0.1 to 1:4, and more preferably 1:0.5 to 1:3.

A temperature of the stretching bath is preferably 30 to 70° C., more preferably 40 to 67° C., and furthermore preferably 50 to 62° C. Dry stretching is preferably performed at 50 to 180° C.

In pulling out of the film from the stretching bath, any appropriate liquid dripping preventing rolls such as pinch rolls may be used as required for preventing liquid dripping, or excess water may be removed through a method of removing a liquid with an air knife or the like.

(Washing Step)

The washing step is typically performed by immersing the polyvinyl alcohol-based resin film subjected to the various treatments in a treatment bath (water washing bath). The washing step allows washing away of undesired remains on the polyvinyl alcohol-based resin film. The washing bath includes an aqueous solution containing potassium iodide as an essential component. The aqueous solution may contain one type or two or more types of compounds selected from lithium iodide, sodium iodide, zinc iodide, aluminum iodide, lead iodide, copper iodide, barium iodide, calcium iodide, tin iodide, and titanium iodide, in addition to potassium iodide. A concentration of potassium iodide is preferably 0.05 to 15 wt %, more preferably 0.1 to 10 wt %, furthermore preferably 3 to 8 wt %, and particularly preferably 0.5 to 8 wt %. The aqueous iodide solution may be added with an auxiliary agent such as zinc sulfate or zinc chloride.

A temperature of the washing bath is preferably 10 to 60° C., more preferably 15 to 40° C., and furthermore preferably 30 to 40° C. An immersion time in the washing bath is preferably 1 second to 1 minute. The washing step may be performed only once, or may be performed several times as required. In the case where the washing step is performed several times, the types and concentrations of additives in the washing bath to be used for each treatment may appropriately be adjusted. For example, the washing step involves: a step of immersing a polymer film in an aqueous solution of potassium iodide (0.1 to 10 wt %, 10 to 60° C.) for 1 second to 1 minute; and a step of washing the polymer film with pure water.

In pulling out of the film from the washing bath, any appropriate liquid dripping preventing rolls such as pinch rolls may be used as required for preventing liquid dripping, or excess water may be removed through a method of removing a liquid with an air knife or the like.

(Drying Step)

Any appropriate drying method (natural drying, air drying, or heat drying, for example) may be employed for the drying step. Heat drying is preferably employed. In heat drying, a drying temperature is preferably 20 to 80° C., more preferably 20 to 60° C., and more preferably 20 to 45° C. A drying time is preferably 1 to 10 minutes. The polarizer is obtained as described above.

C. First Cellulose-Based Film, Second Cellulose-Based Film

In the present invention, the first cellulose-based film 23 has a thickness direction retardation (Rth) represented by an equation (2) of 10 nm or less, preferably 6 nm or less, and furthermore preferably 3 nm or less. A lower limit thereof is preferably 0 nm or more, and the thickness direction retardation preferably exceeds 0 nm.
Rth=(nx−nz)×d (2)

In the present invention, the second cellulose-based film 23′ has a thickness direction retardation (Rth) represented by the equation (2) of 10 nm or less, preferably 6 nm or less, and furthermore preferably 3 nm or less. A lower limit thereof is preferably 0 nm or more, and the thickness direction retardation preferably exceeds 0 nm.
Rth=(nx−nz)×d (2)

In the liquid crystal panel of the present invention, the first cellulose-based film 23 and the second cellulose-based film 23′ each having a very small thickness direction retardation (Rth) as described above are combined with a specific optical compensation layer, the first polarizer, and the second polarizer into a specific structure, to thereby provide a liquid crystal panel and a liquid crystal display apparatus each allowing excellent viewing angle compensation and having excellent contrast in an oblique direction and small color shift.

In the present invention, the first cellulose-based film 23 has an in-plane retardation (Re) represented by an equation (3) of preferably 2 nm or less, and furthermore preferably 1 nm or less. A lower limit thereof is preferably 0 nm or more, and the in-plane retardation preferably exceeds 0 nm.
Re=(nx−ny)×d (3)

In the present invention, the second cellulose-based film 23′ has an in-plane retardation (Re) represented by the equation (3) of preferably 2 nm or less, and furthermore preferably 1 nm or less. A lower limit thereof is preferably 0 nm or more, and the in-plane retardation preferably exceeds 0 nm.
Re=(nx−ny)×d (3)

In the liquid crystal panel of the present invention, the first cellulose-based film 23 and the second cellulose-based film 23′ each having a very small in-plane retardation (Re) as described above are preferably combined with a specific optical compensation layer, the first polarizer, and the second polarizer into a specific structure, to thereby sufficiently provide a liquid crystal panel and a liquid crystal display apparatus each allowing excellent viewing angle compensation and having excellent contrast in an oblique direction and small color shift. The cellulose-based film has so-called reverse dispersion property in which retardation increases with increasing wavelength. Meanwhile, the liquid crystal cell or the optical compensation layer has so-called positive dispersion property in which retardation decreases with increasing wavelength. In the present invention, each of the cellulose-based films has a thickness direction retardation (Rth) of 10 nm or less, to thereby suppress effects of inconsistency in dispersion of the cellulose-based film, the liquid crystal cell, and the optical compensation layer. The inconsistency in dispersion as described above refers to a case where the cellulose-based film has reverse dispersion property and the liquid crystal cell or the optical compensation layer has positive dispersion property.

Any appropriate cellulose-based material may be used for the first cellulose-based film 23 and the second cellulose-based film 23′. A preferred example thereof is an aliphatic acid-substituted cellulose-based polymer such as diacetyl cellulose or triacetyl cellulose.

The cellulose-based film generally used for a transparent protective film such as a triacetyl cellulose film having a thickness of 40 μm has a thickness direction retardation (Rth) of about 40 nm. Thus, the first cellulose-based film 23 and the second cellulose-based film 23′ of the present invention each cannot employ the cellulose-based film having a large thickness direction retardation (Rth) as described above as it is. In the present invention, the cellulose-based film having a large thickness direction retardation (Rth) is subjected to appropriate treatment for reducing the thickness direction retardation (Rth), to thereby preferably provide the first cellulose-based film 23 and the second cellulose-based film 23′ in the present invention.

Any appropriate treatment method may be employed as the treatment for reducing the thickness direction retardation (Rth). Examples thereof include: a method involving attaching a substrate formed of polyethylene terephthalate, polypropylene, stainless steel, or the like having applied thereon a solvent such as cyclopentanone or methyl ethyl ketone to a general cellulose-based film, drying the whole under heat (at about 80 to 150° C. for about 3 to 10 minutes, for example), and peeling the substrate film; and a method involving applying a solution prepared by dissolving a norbornene-based resin, an acrylic resin, or the like in a solvent such as cyclopentanone or methyl ethyl ketone to a general cellulose-based film, drying the whole under heat (at about 80 to 150° C. for about 3 to 10 minutes, for example), and peeling the applied film.

An aliphatic acid-substituted cellulose-based polymer having a controlled degree of aliphatic acid substitution may be used as a material for the each of first cellulose-based film 23 and the second cellulose-based film 23′. Generally used triacetyl cellulose has a degree of acetic acid substitution of about 2.8. However, the degree of acetic acid substitution is controlled to preferably 1.8 to 2.7, and more preferably the degree of propionic acid substitution is controlled to 0.1 to 1, to thereby allow control of the thickness direction retardation (Rth) to a small value.

A plasticizer such as dibutyl phthalate, p-toluenesulfonanilide, or acetyl triethyl citrate may be added to the aliphatic acid-substituted cellulose-based polymer, to thereby allow control of the thickness direction retardation (Rth) to a small value. An amount of the plasticizer added is preferably 40 parts by weight or less, more preferably 1 to 20 parts by weight, and furthermore preferably 1 to 15 parts by weight with respect to 100 parts by weight of the aliphatic acid-substituted cellulose-based polymer.

The above-mentioned techniques for reducing the thickness direction retardation (Rth) to a small value may appropriately be used in combination.

The first cellulose-based film 23 has a thickness of preferably 1 to 500 μm, more preferably 5 to 200 μm, furthermore preferably 20 to 200 μm, particularly preferably 30 to 100 μm, and most preferably 35 to 95 μm for maintaining film strength and controlling the thickness direction retardation (Rth) to a small value.

The second cellulose-based film 23′ has a thickness of preferably 1 to 500 μm, more preferably 5 to 200 μm, furthermore preferably 20 to 200 μm, particularly preferably 30 to 100 μm, and most preferably 35 to 95 μm for maintaining film strength and controlling the thickness direction retardation (Rth) to a small value.

D. Optical Compensation Layer

An Nz coefficient of the optical compensation layer 21 may be optimized in response to display mode of the liquid crystal cell. The Nz coefficient is represented by an equation (1).
Nz=(nx−nz)/(nx−ny) (1)

In the equation (1): nx represents a refractive index in a slow axis direction; ny represents a refractive index in a fast axis direction; and nz represents a refractive index in a thickness direction. The slow axis refers to a direction providing a maximum refractive index in the plane of the film, and the fast axis refers to a direction perpendicular to the slow axis in the plane of the film.

The Nz coefficient is preferably 2≦Nz≦20, more preferably 2≦Nz≦10, furthermore preferably 2≦Nz≦8, and particularly preferably 2≦Nz≦6.

A liquid crystal cell of VA mode has an Nz coefficient of preferably 2≦Nz≦10, more preferably 2≦Nz≦8, and furthermore preferably 2≦Nz≦6.

A liquid crystal cell of OCB mode has an Nz coefficient of preferably 2≦Nz≦20, more preferably 2≦Nz≦10, and furthermore preferably 2≦Nz≦8.

The optical compensation layer 21 preferably has a refractive index profile of nx>ny>nz.

A in-plane retardation (transverse retardation) Re (also represented by Δnd) of the optical compensation layer 21 may be optimized in response to display mode of the liquid crystal cell. The in-plane retardation (transverse retardation) Re can be obtained from an equation: Re=(nx−ny)×d. In the equation: nx represents a refractive index in a slow axis direction; ny represents a refractive index in a fast axis direction; and d(nm) represents a thickness of a birefringent layer. Typically, Re is measured by using light of a wavelength of 590 nm.

A lower limit of Re is preferably 5 nm or more, more preferably 10 nm or more, and most preferably 15 nm or more. Re of less than 5 nm often provides reduced contrast in an oblique direction. Meanwhile, an upper limit of Re is preferably 400 nm or less, more preferably 300 nm or less, furthermore preferably 200 nm or less, particularly preferably 150 nm or less, especially preferably 100 nm or less, and most preferably 80 nm or less. Re of more than 400 nm often provides a small viewing angle. To be specific, a liquid crystal cell of VA mode has Re of preferably 5 to 150 nm, more preferably 10 to 100 nm, and most preferably 15 to 80 nm. A liquid crystal cell of OCB mode has Re of preferably 5 to 400 nm, more preferably 10 to 300 nm, and most preferably 15 to 200 mm.

A thickness direction retardation Rth of the optical compensation layer 21 may be optimized in response to display mode of the liquid crystal cell. Rth can be obtained from an equation: Rth=(nx−nz)×d. Typically, Rth is measured by using light of a wavelength of 590 nm.

A lower limit of Rth is preferably 10 nm or more, more preferably 20 nm or more, and most preferably 50 nm or more. Rth of less than 10 nm often provides reduced contrast in an oblique direction. Meanwhile, an upper limit of Rth is preferably 1,000 nm or less, more preferably 500 nm or less, furthermore preferably 400 nm or less, particularly preferably 300 nm or less, especially preferably 280 nm or less, and most preferably 260 nm or less. When Rth exceeds 1,000 nm, the optical compensation may become too large, and as a result the contrast in an oblique direction may deteriorate.

A liquid crystal cell of VA mode has Rth of preferably 10 to 300 nm, more preferably 20 to 280 nm, and most preferably 50 to 260 nm.

A liquid crystal cell of OCB mode has Rth of preferably 10 to 1,000 nm, more preferably 20 to 500 nm, and most preferably 50 to 400 nm.

The optical compensation layer 21 may be a monolayer or a laminate of two or more layers. In the laminate, a material used for forming each layer and a thickness of each layer may appropriately be set as long as the laminate as a whole has the above-mentioned optical properties.

The optical compensation layer 21 may have any appropriate thickness as long as the effect of the present invention can be provided. Typically, the optical compensation layer 21 has a thickness of preferably 0.1 to 50 μm, more preferably 0.5 to 30 μm, and furthermore preferably 1 to 20 μm for contributing to reduction in thickness of a liquid crystal display apparatus and for providing an optical compensation layer exhibiting excellent viewing angle compensation performance and having even retardation. According to the present invention, excellent viewing angle compensation may be realized by using an optical compensation layer having a significantly small thickness than that of a conventional retardation plate and by using one such optical compensation layer.

Any suitable materials may be employed as a material constituting the optical compensation layer 21 as long as the optical compensation layer has the above optical characteristics. An example of such a material includes anon-liquid crystalline material. The material is particularly preferably a non-liquid crystalline polymer. The non-liquid crystalline material differs from a liquid crystalline material and may form an optically uniaxial film with nx>nz or ny>nz as property of the non-liquid crystalline material, regardless of alignment of the substrate. As a result, the non-liquid crystalline material may employ not only an alignment-treated substrate, but also an untreated substrate in a step of forming the optical compensation layer. Further, a step of applying an alignment layer on a substrate surface, a step of laminating an alignment layer, or the like may be omitted even when an untreated substrate is employed.

A preferred example of the non-liquid crystalline material includes a polymer such as polyamide, polyimide, polyester, polyetherketone, polyamideimide, or polyesterimide since such a material has excellent thermal resistance, excellent chemical resistance, excellent transparency, and sufficient rigidity. One type of polymer may be used, or a mixture of two or more types thereof having different functional groups such as a mixture of polyaryletherketone and polyamide may be used. Of those, polyimide is particularly preferred in view of high transparency, high alignment ability, and high extension.

A molecular weight of the polymer is not particularly limited. However, the polymer has a weight average molecular weight (Mw) of preferably within a range of 1,000 to 1,000,000, more preferably within a range of 2,000 to 500,000, for example.

Polyimide which has high in-plane alignment ability and which is soluble in an organic solvent is preferred as polyimide used in the present invention, for example. More specifically, a polymer disclosed in JP 2000-511296 A, containing a condensation polymerization product of 9,9-bis(aminoaryl)fluorene and aromatic tetracarboxylic dianhydride, and containing at least one repeating unit represented by the following formula (1) can be used.

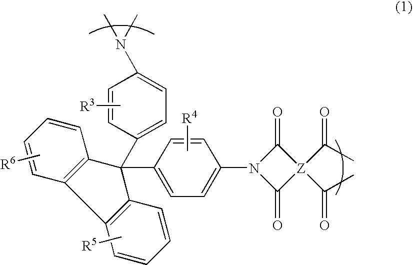

In the above formula (1), R³ to R⁶ independently represent at least one type of substituent selected from hydrogen, a halogen, a phenyl group, a phenyl group substituted with 1 to 4 halogen atoms or 1 to 4 alkyl groups each having 1 to 10 carbon atoms, and an alkyl group having 1 to 10 carbon atoms. Preferably, R³ to R⁶ independently represent at least one type of substituent selected from a halogen, a phenyl group, a phenyl group substituted with 1 to 4 halogen atoms or 1 to 4 alkyl groups each having 1 to 10 carbon atoms, and an alkyl group having 1 to 10 carbon atoms.

In the above formula (1), Z represents a tetravalent aromatic group having 6 to 20 carbon atoms, and preferably represents a pyromellitic group, a polycyclic aromatic group, a derivative of the polycyclic aromatic group, or a group represented by the following formula (2), for example.

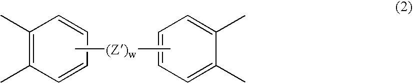

In the above formula (2), Z′ represents a covalent bond, a C(R⁷)₂ group, a CO group, an O atom, an S atom, an SO₂ group, an Si(C₂H₅)₂ group, or an NR⁸ group. A plurality of Z's may be the same or different from each other. w represents an integer of 1 to 10. R⁷s independently represent hydrogen or a C(R⁹)₃ group. R⁸ represents hydrogen, an alkyl group having 1 to about 20 carbon atoms, or an aryl group having 6 to 20 carbon atoms. A plurality of R⁸s may be the same or different from each other. R⁹s independently represent hydrogen, fluorine, or chlorine.

An example of the polycyclic aromatic group includes a tetravalent group derived from naphthalene, fluorene, benzofluorene, or anthracene. An example of the substituted derivative of the polycyclic aromatic group includes the above polycyclic aromatic group substituted with at least a group selected from an alkyl group having 1 to 10 carbon atoms, a fluorinated derivative thereof, and a halogen such as F or Cl.

Other examples of the polyimide include: a homopolymer disclosed in JP 08-511812 A and containing a repeating unit represented by the following general formula (3) or (4); and polyimide disclosed therein and containing a repeating unit represented by the following general formula (5). Note that, polyimide represented by the following formula (5) is a preferred form of the homopolymer represented by the following formula (3).

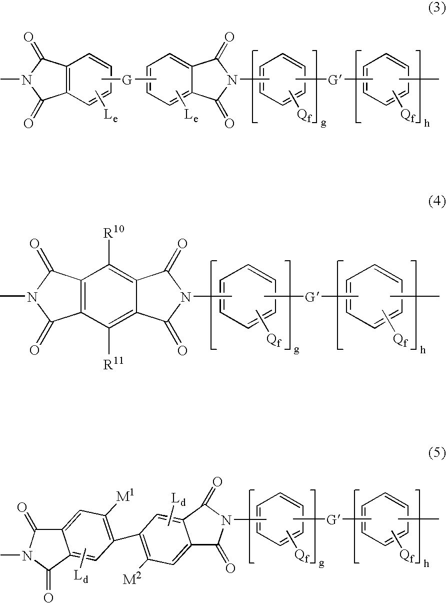

In the above general formulae (3) to (5), G and G′ independently represent a covalent bond, a CH₂ group, a C(CH₃)₂ group, a C(CF₃)₂ group, a C(CX₃)₂ group (wherein, X represents a halogen), a CO group, an O atom, an S atom, an SO₂ group, an Si(CH₂CH₃)₂ group, or an N(CH₃) group, for example. G and G′ may be the same or different from each other.

In the above formulae (3) and (5), L is a substituent, and d and e each represent the number of the substituents. L represents a halogen, an alkyl group having 1 to 3 carbon atoms, a halogenated alkyl group having 1 to 3 carbon atoms, a phenyl group, or a substituted phenyl group, for example. A plurality of Ls may be the same or different from each other. An example of the substituted phenyl group includes a substituted phenyl group having at least one type of substituent selected from a halogen, an alkyl group having 1 to 3 carbon atoms, and a halogenated alkyl group having 1 to 3 carbon atoms, for example. Examples of the halogen include fluorine, chlorine, bromine, and iodine. d represents an integer of 0 to 2, and e represents an integer of 0 to 3.

In the above formulae (3) to (5), Q is a substituent, and f represents the number of the substituents. Q represents an atom or a group selected from hydrogen, a halogen, an alkyl group, a substituted alkyl group, a nitro group, a cyano group, a thioalkyl group, an alkoxy group, an aryl group, a substituted aryl group, an alkyl ester group, and a substituted alkylester group, for example. A plurality of Qs may be the same or different from each other. Examples of the halogen include fluorine, chlorine, bromine, and iodine. An example of the substituted alkyl group includes a halogenated alkyl group. An example of the substituted aryl group includes a halogenated aryl group. f represents an integer of 0 to 4, and g represents an integer of 0 to 3. h represents an integer of 1 to 3. g and h are each preferably larger than 1.

In the above formula (4), R¹⁰ and R¹¹ independently represent an atom or a group selected from hydrogen, a halogen, a phenyl group, a substituted phenyl group, an alkyl group, and a substituted alkyl group. Preferably, R¹⁰ and R¹¹ independently represent a halogenated alkyl group.

In the above formula (5), M¹ and M² independently represent a halogen, an alkyl group having 1 to 3 carbon atoms, a halogenated alkyl group having 1 to 3 carbon atoms, a phenyl group, or a substituted phenyl group, for example. Examples of the halogen include fluorine, chlorine, bromine, and iodine. An example of the substituted phenyl group includes a substituted phenyl group having at least one type of substituent selected from the group consisting of a halogen, an alkyl group having 1 to 3 carbon atoms, and a halogenated alkyl group having 1 to 3 carbon atoms.

A specific example of the polyimide represented by the above formula (3) includes a compound represented by the following formula (6).

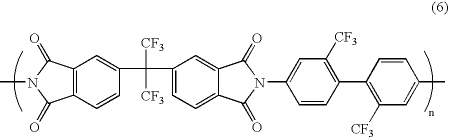

Another example of the polyimide includes a copolymer prepared through arbitrary copolymerization of acid dianhydride having a skeleton (repeating unit) other than that as described above and diamine.

An example of the acid dianhydride includes an aromatic tetracarboxylic dianhydride. Examples of the aromatic tetracarboxylic dianhydride include pyromellitic dianhydride, benzophenone tetracarboxylic dianhydride, naphthalene tetracarboxylic dianhydride, heterocyclic aromatic tetracarboxylic dianhydride, and 2,2′-substituted biphenyltetracarboxylic dianhydride.

Examples of the pyromellitic dianhydride include: pyromellitic dianhydride; 3,6-diphenyl pyromellitic dianhydride; 3,6-bis(trifluoromethyl)pyromellitic dianhydride; 3,6-dibromopyromellitic dianhydride; and 3,6-dichloropyromellitic dianhydride. Examples of the benzophenone tetracarboxylic dianhydride include: 3,3′,4,4′-benzophenone tetracarboxylic dianhydride; 2,3,3′,4′-benzophenone tetracarboxylic dianhydride; and 2,2′,3,3′-benzophenone tetracarboxylic dianhydride. Examples of the naphthalene tetracarboxylic dianhydride include: 2,3,6,7-naphthalene tetracarboxylic dianhydride; 1,2,5,6-naphthalene tetracarboxylic dianhydride; and 2,6-dichloronaphthalene-1,4,5,8-tetracarboxylic dianhydride. Examples of the heterocyclic aromatic tetracarboxylic dianhydride include: thiophene-2,3,4,5-tetracarboxylic dianhydride; pyrazine-2,3,5,6-tetracarboxylic dianhydride; and pyridine-2,3,5,6-tetracarboxylic dianhydride. Examples of the 2,2′-substituted biphenyltetracarboxylic dianhydride include: 2,2′-dibromo-4,4′,5,5′-biphenyltetracarboxylic dianhydride; 2,2′-dichloro-4,4′,5,5′-biphenyltetracarboxylic dianhydride; and 2,2′-bis(trifluoromethyl)-4,4′,5,5′-biphenyltetracarboxylic dianhydride.

Further examples of the aromatic tetracarboxylic dianhydride include: 3,3′,4,4′-biphenyltetracarboxylic dianhydride; bis(2,3-dicarboxyphenyl)methane dianhydride; bis(2,5,6-trifluoro-3,4-dicarboxyphenyl)methane dianhydride; 2,2-bis(3,4-dicarboxyphenyl)-1,1,1,3,3,3-hexafluoropropane dianhydride; 4,4′-bis(3,4-dicarboxyphenyl)-2,2-diphenylpropane dianhydride; bis(3,4-dicarboxyphenyl)ether dianhydride; 4,4′-oxydiphthalic dianhydride; bis(3,4-dicarboxyphenyl)sulfonic dianhydride; 3,3′,4,4′-diphenylsulfone tetracarboxylic dianhydride; 4,4′-[4,4′-isopropylidene-di(p-phenyleneoxy)]bis(phthalic anhydride); N,N-(3,4-dicarboxyphenyl)-N-methylamine dianhydride; and bis(3,4-dicarboxyphenyl)diethylsilane dianhydride.

Of those, the aromatic tetracarboxylic dianhydride is preferably 2,2′-substituted biphenyltetracarboxylic dianhydride, more preferably 2,2′-bis(trihalomethyl)-4,4′,5,5′-biphenyltetracarboxylic dianhydride, and furthermore preferably 2,2′-bis(trifluoromethyl)-4,4′,5,5′-biphenyltetracarboxylic dianhydride.

An example of the diamine includes aromatic diamine. Specific examples of the aromatic diamine include benzenediamine, diaminobenzophenone, naphthalenediamine, heterocyclic aromatic diamine, and other aromatic diamines.

Examples of the benzenediamine include benzenediamines such as o-, m-, or p-phenylenediamine, 2,4-diaminotoluene, 1,4-diamino-2-methoxybenzene, 1,4-diamino-2-phenylbenzene, and 1,3-diamino-4-chlorobenzene. Examples of the diaminobenzophenone include 2,2′-diaminobenzophenone and 3,3′-diaminobenzophenone. Examples of the naphthalenediamine include 1,8-diaminonaphthalene and 1,5-diaminonaphthalene. Examples of the heterocyclic aromatic diamine include 2,6-diaminopyridine, 2,4-diaminopyridine, and 2,4-diamino-S-triazine.

Further examples of the aromatic diamine include: 4,4′-diaminobiphenyl; 4,4′-diaminodiphenylmethane; 4,4′-(9-fluorenylidene)-dianiline; 2,2′-bis(trifluoromethyl)-4,4′-diaminobiphenyl; 3,3′-dichloro-4,4′-diaminodiphenylmethane; 2,2′-dichloro-4,4′-diaminobiphenyl; 2,2′,5,5′-tetrachlorobenzidine; 2,2-bis(4-aminophenoxyphenyl)propane; 2,2-bis(4-aminophenyl)propane; 2,2-bis(4-aminophenyl)-1,1,1,3,3,3-hexafluoropropane; 4,4′-diaminodiphenyl ether; 3,4′-diaminodiphenyl ether; 1,3-bis(3-aminophenoxy)benzene; 1,3-bis(4-aminophenoxy)benzene; 1,4-bis(4-aminophenoxy)benzene; 4,4′-bis(4-aminophenoxy)biphenyl; 4,4′-bis(3-aminophenoxy)biphenyl; 2,2-bis[4-(4-aminophenoxy)phenyl]propane; 2,2-bis[4-(4-aminophenoxy)phenyl]-1,1,1,3,3,3-hexafluoropropane; 4,4′-diaminodiphenyl thioether; and 4,4′-diaminodiphenylsulfone.

An example of the polyetherketone includes polyaryletherketone disclosed in JP 2001-049110 A and represented by the following general formula (7).

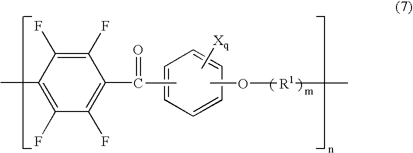

In the above formula (7), X represents a substituent, and q represents the number of the substituents. X represents a halogen atom, a lower alkyl group, a halogenated alkyl group, a lower alkoxy group, or a halogenated alkoxy group, for example. A plurality of Xs may be the same or different from each other.

Examples of the halogen atom include a fluorine atom, a bromine atom, a chlorine atom, and an iodine atom. Of those, a fluorine atom is preferred. The lower alkyl group is preferably an alkyl group having a straight chain or branched chain of 1 to 6 carbon atoms, more preferably an alkyl group having a straight chain or branched chain of 1 to 4 carbon atoms. More specifically, the lower alkyl group is preferably a methyl group, an ethyl group, a propyl group, an isopropyl group, a butyl group, an isobutyl group, a sec-butyl group, or a tert-butyl group, and particularly preferably a methyl group or an ethyl group. An example of the halogenated alkyl group includes a halide of the above lower alkyl group such as a trifluoromethyl group. The lower alkoxy group is preferably an alkoxy group having a straight chain or branched chain of 1 to 6 carbon atoms, more preferably an alkoxy group having a straight chain or branched chain of 1 to 4 carbon atoms. More specifically, the lower alkoxy group is preferably a methoxy group, an ethoxy group, a propoxy group, an isopropoxy group, a butoxy group, an isobutoxy group, a sec-butoxy group, or a tert-butoxy group, and particularly preferably a methoxy group or an ethoxy group. An example of the halogenated alkoxy group includes a halide of the above lower alkoxy group such as a trifluoromethoxy group.

In the above formula (7), q is an integer of 0 to 4. In the above formula (7), preferably, q=0, and a carbonyl group and an oxygen atom of ether bonded to both ends of a benzene ring are located in para positions.

In the above formula (7), R¹ is a group represented by the following formula (8), and m is an integer of 0 or 1.

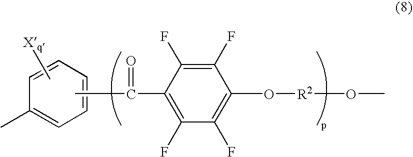

In the above formula (8), X′ represents a substituent which is the same as X in the above formula (7), for example. In the above formula (8), a plurality of X's may be the same or different from each other. q′ represents the number of the substituents X′. q′ is an integer of 0 to 4, and q′ is preferably 0. p is an integer of 0 or 1.

In the above formula (8), R² represents a divalent aromatic group. Examples of the divalent aromatic group include: an o-, m-, or p-phenylene group; and a divalent group derived from naphthalene, biphenyl, anthracene, o-, m-, or p-terphenyl, phenanthrene, dibenzofuran, biphenyl ether, or biphenyl sulfone. In the divalent aromatic group, hydrogen directly bonded to an aromatic group may be substituted with a halogen atom, a lower alkyl group, or a lower alkoxy group. Of those, R² is preferably an aromatic group selected from groups represented by the following formulae (9) to (15).

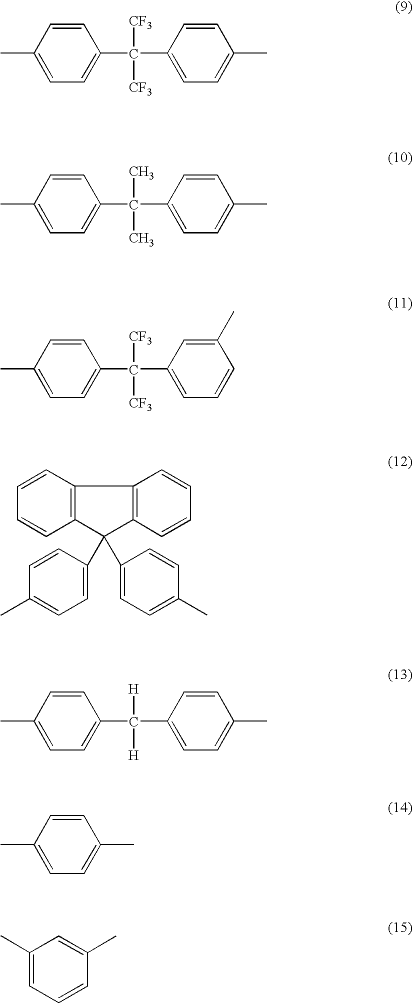

In the above formula (7), R¹ is preferably a group represented by the following formula (16). In the following formula (16), R² and p are defined as those in the above formula (8).

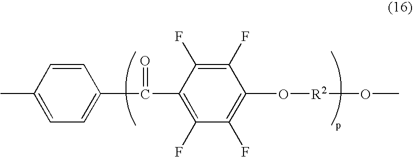

In the above formula (7), n represents a degree of polymerization. n falls within a range of 2 to 5,000, preferably within a range of 5 to 500, for example. Polymerization may involve polymerization of repeating units of the same structure or polymerization of repeating units of different structures. In the latter case, a polymerization form of the repeating units may be block polymerization or random polymerization.

Terminals of the polyaryletherketone represented by the above formula (7) are preferably a fluorine atom on a p-tetrafluorobenzoylene group side and a hydrogen atom on an oxyalkylene group side. Such polyaryletherketone can be represented by the following general formula (17), for example. In the following formula (17), n represents the same degree of polymerization as that in the above formula (7).

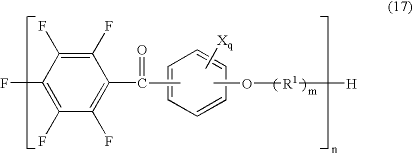

Specific examples of the polyaryletherketone represented by the above formula (7) include compounds represented by the following formulae (18) to (21). In each of the following formulae, n represents the same degree of polymerization as that in the above formula (7).

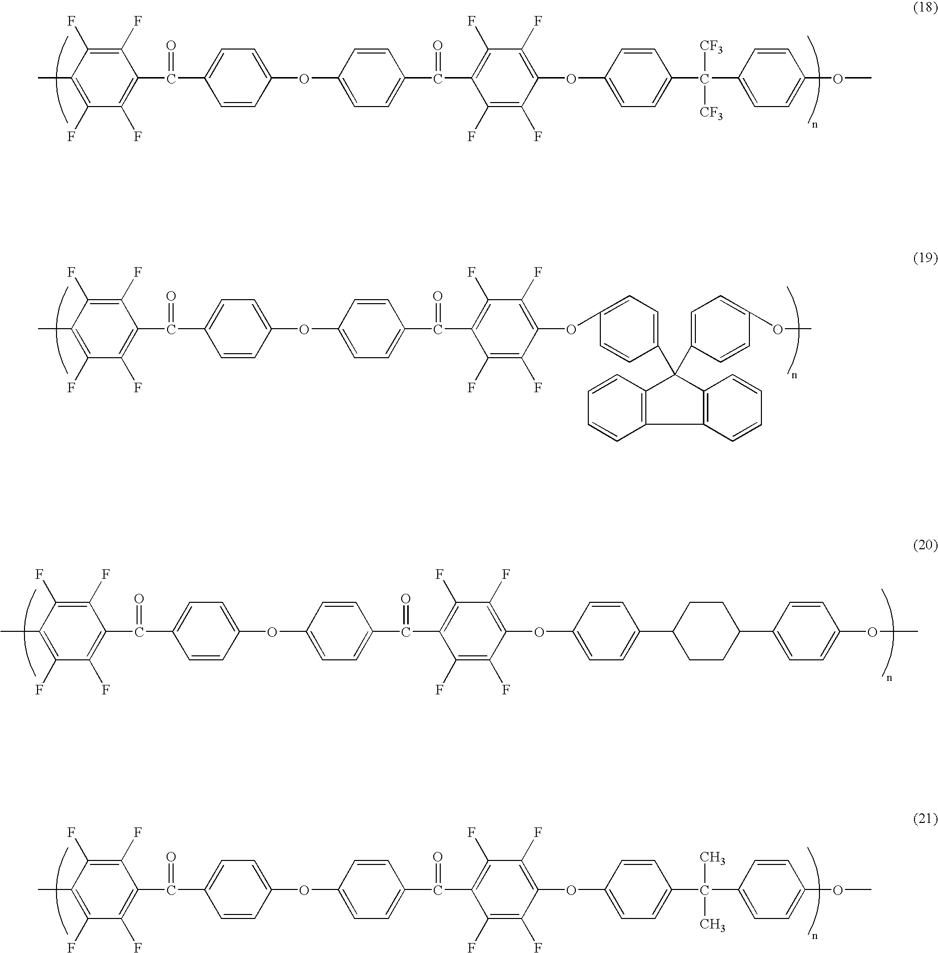

In addition, an example of polyamide or polyester includes polyamide or polyester disclosed in JP 10-508048 A. A repeating unit thereof can be represented by the following general formula (22), for example.

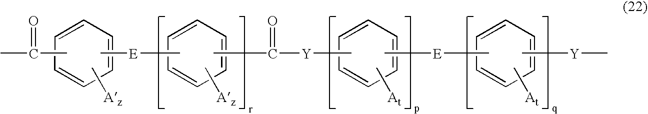

In the above formula (22), Y represents O or NH. E represents at least one selected from a covalent bond, an alkylene group having 2 carbon atoms, a halogenated alkylene group having 2 carbon atoms, a CH₂ group, a C(CX₃)₂ group (wherein, X is a halogen or hydrogen), a CO group, an O atom, an S atom, an SO₂ group, an Si(R)₂ group, and an N(R) group, for example. A plurality of Es may be the same or different from each other. In E, R is at least one of an alkyl group having 1 to 3 carbon atoms and a halogenated alkyl group having 1 to 3 carbon atoms, and is located in a meta or para position with respect to a carbonyl functional group or a Y group.

In the above formula (22), A and A′ each represent a substituent, and t and z represent the numbers of the respective substituents. p represents an integer of 0 to 3, and q represents an integer of 1 to 3. r represents an integer of 0 to 3.

A is selected from hydrogen, a halogen, an alkyl group having 1 to 3 carbon atoms, a halogenated alkyl group having 1 to 3 carbon atoms, an alkoxy group represented by OR (wherein, R is defined as above), an aryl group, a substituted aryl group prepared through halogenation or the like, an alkoxycarbonyl group having 1 to 9 carbon atoms, an alkylcarbonyloxy group having 1 to 9 carbon atoms, an aryloxycarbonyl group having 1 to 12 carbon atoms, an arylcarbonyloxy group having 1 to 12 carbon atoms and its substituted derivatives, an arylcarbamoyl group having 1 to 12 carbon atoms, and arylcarbonylamino group having 1 to 12 carbon atoms and its substituted derivatives, for example. A plurality of As may be the same or different from each other. A′ is selected from a halogen, an alkyl group having 1 to 3 carbon atoms, a halogenated alkyl group having 1 to 3 carbon atoms, a phenyl group, and a substituted phenyl group, for example. A plurality of A's may be the same or different from each other. Examples of the substituent on a phenyl ring of the substituted phenyl group include a halogen, an alkyl group having 1 to 3 carbon atoms, a halogenated alkyl group having 1 to 3 carbon atoms, and the combination thereof. t represents an integer of 0 to 4, and z represents an integer of 0 to 3.

The repeating unit of the polyamide or polyester represented by the above formula (22) is preferably a repeating unit represented by the following general formula (23).

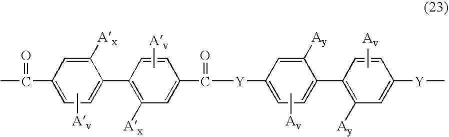

In the above formula (23), A, A′, and Y are defined as those in the above formula (22). v represents an integer of 0 to 3, preferably an integer of 0 to 2. x and y are each 0 or 1, but are not both 0.

Next, description will be given of a method of producing an optical compensation layer. Any appropriate method may be employed for the method of producing an optical compensation layer as long as the effect of the present invention can be provided.

The optical compensation layer is formed by: applying a solution of at least one polymer selected from the group consisting of polyamide, polyimide, polyester, polyetherketone, polyamideimide, and polyesterimide to the first cellulose-based film of the present invention; drying the whole to form the polymer layer on the first cellulose-based film; and stretching or contracting the first cellulose-based film and the polymer layer integrally.

A solvent in the application solution (a polymer solution to be applied to a first cellulose-based film in the present invention) is not particularly limited. Examples of the solvent include: halogenated hydrocarbons such as chloroform, dichloromethane, carbon tetrachloride, dichloroethane, tetrachloroethane, trichloroethylene, tetrachloroethylene, chlorobenzene, and orthodichlorobenzene; phenols such as phenol and p-chlorophenol; aromatic hydrocarbons such as benzene, toluene, xylene, methoxybenzene, and 1,2-dimethoxybenzene; ketone-based solvents such as acetone, methyl ethyl ketone, methyl isobutyl ketone, cyclohexanone, cyclopentanone, 2-pyrrolidone, and N-methyl-2-pyrrolidone; ester-based solvents such as ethyl acetate and butyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; and ether-based solvents such as diethyl ether, dibutyl ether, and tetrahydrofuran; and carbon disulfide, ethyl cellosolve, and butyl cellosolve. Of those, methyl isobutyl ketone is preferred, because methyl isobutyl ketone exhibits high solubility in a non-liquid crystal material and does not corrode a substrate. Those solvents may be used alone or in combination of two or more types thereof.

The application solution may have any appropriate concentration of the non-liquid crystalline polymer as long as the above-mentioned optical compensation layer can be obtained and the application solution can be applied. For example, the solution contains preferably 5 to 50 parts by weight, and more preferably 10 to 40 parts by weight of the non-liquid crystalline polymer with respect to 100 parts by weight of the solvent. The solution having such a concentration range has a viscosity allowing easy application.

The application solution may further contain various additives such as a stabilizer, a plasticizer, and metals as required.

The application solution may further contain another resin as required. Examples of another resin include various general purpose resins, engineering plastics, a thermoplastic resin, and a heat-curable resin. Such a resin is used in combination, to thereby allow formation of an optical compensation layer having appropriate mechanical strength or durability in accordance with the purpose.

Examples of the above-mentioned general purpose resin include polyethylene (PE), polypropylene (PP), polystyrene (PS), polymethylmethacryrate (PMMA), an ABS resin, and an AS resin. Examples of the above-mentioned engineering plastics include polyacetate (POM), polycarbonate (PC), polyamide (PA: nylon), polyethylene terephthalate (PET), and polybutylene terephthalate (PBT). Examples of the above-mentioned thermoplastic resin include polyphenylene sulfide (PPS), polyether sulfone (PES), polyketone (PK), polyimide (PI), polycyclohexanedimethanol terephthalate (PCT), polyarylate (PAR), and a liquid crystal polymer (LCP). Examples of the above-mentioned heat-curable resin include an epoxy resin and a phenol novolac resin.

The type and amount of another resin to be added to the application solution may appropriately be set in accordance with the purpose. For example, such a resin is added to the application solution in a ratio of preferably 0 to 50 weight %, and more preferably 0 to 30 weight % with respect to the non-liquid crystalline polymer.

Examples of the application method include: a spin coating method; a roll coating method; a flow coating method; a printing method; a dip coating method; a flow casting method; a bar coating method; and a gravure printing method. For application, a polymer layer superposition method may also be used as required.

After application, the solvent in the above-mentioned solution is evaporated and removed by drying such as natural drying, air drying, or heat drying (at 60 to 250° C., for example), to thereby form a film-like optical compensation layer.

An in-plane difference in refractive index (nx>ny) and optical biaxial property (nx>ny>nz) are assuredly provided to the optical compensation layer by: applying a solution of at least one polymer selected from the group consisting of polyamide, polyimide, polyester, polyetherketone, polyamideimide, and polyesterimide to the first cellulose-based film; drying the whole to form the polymer layer on the first cellulose-based film; and stretching or contracting the first cellulose-based film and the polymer layer integrally. To be specific, for a method involving contraction, the above-mentioned solution is applied to the first cellulose-based film subjected to the stretching treatment and dried, to thereby contract the first cellulose-based film and the polymer layer integrally and attain optical biaxial property. By a method involving stretching, the above-mentioned solution is applied to the unstretched first cellulose-based film and dried, and the whole is stretched under heating, to thereby stretch the first cellulose-based film and the polymer layer integrally and attain optical biaxial property. In this way, the laminate (hereinafter, may be referred to as laminate A) having the optical compensation layer formed on the first cellulose-based film is obtained.

E. Transparent Protective Layer

The liquid crystal panel 100 of the present invention may include a transparent protective layer on an outer side (that is, as an outermost layer) of the polarizer (first polarizer 30 and/or second polarizer 50) as required. The transparent protective layer is provided, to thereby prevent degradation of the polarizer.

Any appropriate protective layer can be employed for a transparent protective layer in accordance with the purpose. The transparent protective layer may be composed of, for example, plastic films excellent in transparency, mechanical strength, thermostability, water repellency, isotropy, or the like. Specific examples of the resin of which a plastic film is composed include a cellulose resin such as triacetyl cellulose (TAC), an acetate resin, a polyester resin, a polyether sulfone resin, a polysulfone resin, a polycarbonate resin, a polyamide resin, a polyimide resin, a polyolefin resin, an acryl resin, a polynorbornene resin, a polyarylate resin, a polystyrene resin, a polyvinyl alcohol resin, a polyacryl resin, and mixtures thereof. In addition, a heat-curable resin or UV setting resin of an acryl-based, urethane-based, acrylurethane-based, epoxy-based, silicone-based resin, or the like can be used. A TAC film having a surface subjected to saponification with alkali or the like is preferred in view of polarization property and durability.

Further, a polymer film formed of a resin composition as described in JP 2001-343529 A (WO 01/37007), for example, may be used for the transparent protective layer. To be specific, the resin composition refers to a mixture of: a thermoplastic resin having a substituted imide group or an unsubstituted imide group on a side chain; and a thermoplastic resin having a substituted phenyl group or an unsubstituted phenyl group, and a cyano group on a side chain. A specific example thereof is a resin composition containing: an alternating copolymer of isobutene and N-methylene maleimide; and an acrylonitrile/styrene copolymer. An extrusion molded product of such a resin composition may be used, for example.

The transparent protective layer is transparent as its name suggests and preferably has no color. To be specific, the transparent protective layer has a thickness direction retardation Rth of preferably −90 nm to +75 nm, more preferably −80 nm to +60 nm, and most preferably −70 nm to +45 nm. A thickness direction retardation Rth of the transparent protective layer within the above ranges may resolve optical coloring of the polarizer caused by the protective layer.

A thickness of the transparent protective layer may appropriately be set in accordance with the purpose. The transparent protective layer has a thickness of typically 500 μm or less, preferably 5 to 300 μm, and furthermore preferably 5 to 150 μm.

F. Lamination of First Polarizer and Laminate A

In the present invention, the laminate A (laminate having the optical compensation layer 21 formed on the first cellulose-based film 23) is preferably bonded to the first polarizer 30 through an adhesive layer. The bonding between the laminate A and the first polarizer 30 is preferably performed by bonding the first cellulose-based film 23 side of the laminate A to the first polarizer 30.

A transparent protective layer may be attached to another side of the first polarizer 30.

The laminate A and the first polarizer 30 are preferably bonded through an adhesive layer formed of an adhesive. The adhesive layer is preferably a layer formed of a polyvinyl alcohol-based adhesive. The polyvinyl alcohol-based adhesive contains a polyvinyl alcohol-based resin and a crosslinking agent.

Examples of the above-mentioned polyvinyl alcohol-based resin include without particular limitation: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft, or phosphate. Examples of the monomer include: maleic (anhydrides), fumaric acid, crotonic acid, itaconic acid, and unsaturated carboxylic acids such as (meth)acrylic acid and esters thereof; α-orefin such as ethylene and propylene; (sodium) (meth)allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. The polyvinyl alcohol-based resins may be used alone or in combination of two or more thereof.

The polyvinyl alcohol-based resin has an average degree of polymerization of preferably 100 to 3,000, and more preferably 500 to 3,000, and an average degree of saponification of 85 to 100 mol %, and more preferably 90 to 100 mol % from a viewpoint of adhesive property.

A polyvinyl alcohol-based resin having an acetoacetyl group may be used as the above-mentioned polyvinyl alcohol-based resin. The polyvinyl alcohol-based resin having an acetoacetyl group is a polyvinyl alcohol-based adhesive having a highly reactive functional group and is preferred from the viewpoint of improving durability of an optical film to be obtained.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, and adding diketene thereto. Another example of the known method is a method involving directly bringing diketene gas or a liquid diketene into contact with polyvinyl alcohol.

A degree of acetoacetyl modification of the polyvinyl alcohol-based resin having an acetoacetyl group is not particularly limited as long as it is 0.1 mol % or more. A degree of acetoacetyl modification of less than 0.1 mol % provides insufficient water resistance of the adhesive layer and is inappropriate. The degree of acetoacetyl modification is preferably 0.1 to 40 mol %, and more preferably 1 to 20 mol %. A degree of acetoacetyl modification of more than 40 mol % decreases the number of reaction sites with a crosslinking agent and provides a small effect of improving the water resistance. The degree of acetoacetyl modification is a value measured by NMR.

A crosslinking agent used for the polyvinyl alcohol-based adhesive may be used without particular limitation.

A compound having at least two functional groups each having reactivity with a polyvinyl alcohol-based resin can be used as a crosslinking agent. Examples of the compound include: alkylene diamines having an alkylene group and two amino groups such as ethylene diamine, triethylene amine, and hexamethylene dimamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethane)triisocyanate, isophorone diisocyanate, or ketoxime blocked compounds thereof or phenol blocked compounds thereof; epoxides such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino/formaldehyde resin such as a condensate of formaldehyde with methylolurea, methylolmelamine, alkylated methylolurea, alkylated methylol melamine, acetoguanamine, or benzoguanamine; and salts of divalent metals or trivalent metals such as sodium, potassium, magnesium, calcium, aluminium, iron, and nickel and oxides thereof. A melamine-based crosslinking agent is preferred as a crosslinking agent, and methylolmelamine is particularly preferred.

A mixing amount of the crosslinking agent is preferably 0.1 to 35 parts by weight, and more preferably 10 to 25 parts by weight with respect to 100 parts by weight of the polyvinyl alcohol-based resin. Meanwhile, for improving the durability, the crosslinking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the crosslinking agent is preferably used in an amount of more than 30 parts by weight. The crosslinking agent is mixed within a range of more than 30 parts by weight and 46 parts by weight or less, to thereby improve the water resistance.

Note that the above-mentioned polyvinyl alcohol-based adhesive may further contain: a coupling agent such as a silane coupling agent or a titanium coupling agent; various tackifiers; a UV absorber; an antioxidant; and a stabilizer such as a heat resistant stabilizer or a hydrolysis resistant stabilizer.

The laminate A may be subjected to an easy bonding treatment on a surface (preferably, the first cellulose-based film 23 surface) in contact with the first polarizer 30 for improving adhesive property. Examples of the easy bonding treatment include a corona treatment, a plasma treatment, a low-pressure UV treatment, a surface treatment such as a saponification treatment, and a method of forming an anchor layer, and those may be used in combination. Of those, a corona treatment, a method of forming an anchor layer, and a method of combining the corona treatment and the method of forming an anchor layer are preferred.

An example of the anchor layer is a silicone layer having a reactive functional group. A material for the silicone layer having a reactive functional group is not particularly limited. However, examples thereof include: isocyanate group-containing alkoxy silanols; amino group-containing alkoxy silanols; mercapto group-containing alkoxy silanols; carboxy group-containing alkoxy silanols; epoxy group-containing alkoxy silanols; unsaturated vinyl group-containing alkoxy silanols; halogen group-containing alkoxy silanols; and isocyanate group-containing alkoxy silanols. Amino-based silanols are preferred. A titanium-based catalyst or a tin-based catalyst for effectively reacting the silanols may be added, to thereby enhance the adhesive strength. The silicone having a reactive functional group may contain other additives added. Specific examples thereof that may be used include: a tackifier formed of a terpene resin, a phenol resin, a terpene/phenol resin, a rosin resin, a xylene resin, or the like; a UV absorber; an antioxidant; and a stabilizer such as a heat resistant stabilizer.

The silicone layer having a reactive functional group is formed by applying and drying through a known method. The silicone layer has a thickness of preferably 1 to 100 nm, and more preferably 10 to 50 nm after drying. For application, silicone having a reactive functional group may be diluted with a solvent. A diluting solvent is not particularly limited, but examples thereof include alcohols. A dilution concentration is not particularly limited, but is preferably 1 to 5 wt %, and more preferably 1 to 3 wt %.

The adhesive layer is preferably formed by applying the adhesive on the first cellulose-based film 23 side of the laminate A and on one or both sides of the first polarizer 30. After the first cellulose-based film 23 side of the laminate A and the first polarizer 30 are attached together, the whole is preferably subjected to drying step to form an adhesive layer formed of the applied and dried layer. The adhesive layer may be formed and then attached. The laminate A and the first polarizer 30 may be attached by using a roll laminator or the like. A heat drying temperature and a drying time may appropriately be determined in accordance with the type of adhesive.

The adhesive layer has a thickness of preferably 0.01 to 10 μm, and more preferably 0.03 to 5 μm because too large a thickness after drying is not preferred from the viewpoint of adhesive property with the laminate A.

The laminate of the laminate A and the first polarizer 30 may further include a pressure-sensitive adhesive layer as at least one outer most layer (preferably, on the optical compensation layer 21 side of the laminate A). The pressure-sensitive adhesive layer is provided to bond with other members of other optical films, liquid crystal cells, or the like.

The pressure-sensitive adhesive for forming the pressure-sensitive adhesive layer is not particularly limited. For example, pressure-sensitive adhesives each containing as a base polymer a polymer such as an acrylic polymer, a silicone-based polymer, polyester, polyurethane, polyamide, polyether, a fluorine-base polymer, and rubber-based polymer can be arbitrarily selectively used. In particular, an acrylic pressure-sensitive adhesive may preferably used from the viewpoint of excellent optical transparency, moderate wet property, moderate cohesiveness, moderate adhesive property such as adhesiveness, and excellent weatherability and heat resistance. In particular, an acrylic pressure-sensitive adhesive composed of an acrylic polymer having 4 to 12 carbon atoms is preferred.

The pressure-sensitive adhesive layer preferably has low water absorption and excellent heat resistance from the viewpoints of preventing a foaming phenomenon or peeling phenomenon due to water absorption, preventing degradation of optical properties or warping of the liquid crystal cell due to difference in thermal expansion or the like, and forming a high-quality liquid crystal display apparatus having excellent durability.

The pressure-sensitive adhesive layer may contain additives which may be added to a pressure-sensitive adhesive layer such as resins of: natural substances or synthetic substances, in particular, a tackifying resin; a filler formed of glass fiber, glass beads, metal powder, or other inorganic powder; a pigment; a colorant; or an antioxidant.

The pressure-sensitive adhesive layer may be a pressure-sensitive adhesive layer containing fine particles to exhibit light diffusion property.

The pressure-sensitive adhesive layer may be provided through any appropriate method. Examples thereof include: a method involving preparing an about 10 to 40 wt % pressure-sensitive adhesive solution containing a base polymer or its composition dissolved or dispersed in an appropriate single solvent such as toluene or ethyl acetate or a mixed solvent thereof, and directly providing the solution on an optical film (the optical compensation layer 21, for example) through an appropriate developing method such as a flow casting method or an application method; and a method involving forming a pressure-sensitive adhesive layer on a separator as described above, and transferring and bonding the pressure-sensitive adhesive layer to a surface of an optical film (the optical compensation layer 21, for example).

The pressure-sensitive adhesive layer may be provided on one surface or both surfaces of an optical film (the optical compensation layer 21, for example) as a superimposed layer of different compositions, types, or the like. In the case where the pressure-sensitive adhesive layer is provided on each surface of the optical film, pressure-sensitive adhesive layers of different compositions, types, thicknesses, and the like may be provided on front and back surfaces of the optical film.

A thickness of the pressure-sensitive adhesive layer may appropriately be determined in accordance with the intended use or the adhesive strength, and is preferably 1 to 40 μm, more preferably 5 to 30 μm, and particularly preferably 10 to 25 μm. A thickness of less than 1 μm degrades the durability, and a thickness of more than 40 μm is liable to cause floating or peeling due to foaming and provides poor appearance.

An anchor layer may be provided between the optical film (the optical compensation layer 21, for example) and the pressure-sensitive adhesive layer for improving the adhesive property therebetween.

An anchor layer selected from polyurethane, polyester, and polymers each having an amino group in a molecule is preferably used as the anchor layer. Particularly preferably, polymers each having an amino acid in a molecule are used. A polymer having an amino group in a molecule assures favorable adhesiveness because the amino group in a molecule reacts or exhibits interaction such as ionic interaction with a carboxyl group in the pressure-sensitive adhesive or with a polar group in a conductive polymer.

Examples of the polymers each having an amino group in a molecule include: polyethyleneimine; polyallylamine; polyvinylamine; polyvinylpyridine; polyvinylpyrrolidine; and a polymer of an amino group-containing monomer such as dimethylaminoethyl acrylate exemplified for the copolymer monomer of the above-mentioned acrylic pressure-sensitive adhesive.

An antistatic agent may be added for providing antistatic property to the anchor layer. Examples of the antistatic agent for providing antistatic property include: an ionic surfactant-based antistatic agent; a conductive polymer-based antistatic agent such as polyaniline, polythiophene, polypyrrole, and polyquinoxaline; and a metal oxide-based antistatic agent such as tin oxide, antimony oxide, and indium oxide. In particular, the conductive polymer-based antistatic agent is preferably used from the viewpoints of optical properties, appearance, antistatic effect, and stability of the antistatic effect under heating and under moisture. Of those, a water-soluble conductive polymer such as polyaniline or polythiophene, or water-dispersed conductive polymer is particularly preferably used because in the case where the water-soluble conductive polymer or the water-dispersed conductive polymer is used as a material forming an antistatic layer, modification of an optical film substrate by an organic solvent during the application step may be suppressed.

In the present invention, the first polarizer 30, the first cellulose-based film 23, the optical compensation layer 21, the adhesive layer, the pressure-sensitive adhesive layer, and the like may each have UV absorbing ability by being treated with a UV absorber such as a salicylate-based compound, a benzophenol-based compound, a benzotriazole-based compound, a cyano acrylate-based compound, or a nickel complex-based compound.

G. Lamination of Second Polarizer and Second Cellulose-Based Film

In the present invention, the second cellulose-based film 23′ is preferably bonded to the second polarizer 50 through an adhesive layer.

A transparent protective layer may be attached to another side of the second polarizer 50.

The adhesive layer is preferably formed of a polyvinyl alcohol-based adhesive. The polyvinyl alcohol-based adhesive contains a polyvinyl alcohol-based resin and a crosslinking agent.

The same polyvinyl alcohol-based resin and crosslinking agent as those described in the above section E may be employed as the polyvinyl alcohol-based resin and the crosslinking agent.

The second cellulose-based film 23′ may be subjected to an easy bonding treatment on a surface in contact with the second polarizer 50 for improving the adhesive property. Examples of the easy bonding treatment include a corona treatment, a plasma treatment, a low-pressure UV treatment, a surface treatment such as a saponification treatment, and a method of forming an anchor layer, and those may be used in combination. Of those, a corona treatment, a method of forming an anchor layer, and a method of combining the corona treatment and the method of forming an anchor layer are preferred.

An example of the anchor layer is a silicone layer having a reactive functional group. A material for the silicone layer having a reactive functional group is not particularly limited. However, examples thereof include: isocyanate group-containing alkoxy silanols; amino group-containing alkoxy silanols; mercapto group-containing alkoxy silanols; carboxy group-containing alkoxy silanols; epoxy group-containing alkoxy silanols; vinyl unsaturated group-containing alkoxy silanols; halogen group-containing alkoxy silanols; and isocyanate group-containing alkoxy silanols. Amino-based silanols are preferred. A titanium-based catalyst or a tin-based catalyst for effectively reacting the silanols may be added, to thereby enhance the adhesive strength. The silicone having a reactive functional group may contain other additives added. Specific examples thereof that may be used include: a tackifier formed of a terpene resin, a phenol resin, a terpene/phenol resin, a rosin resin, a xylene resin, or the like; a UV absorber; an antioxidant; and a stabilizer such as a heat resistant stabilizer.

The silicone layer having a reactive functional group is formed by applying and drying through a known method. The silicone layer has a thickness of preferably 1 to 100 nm, and more preferably 10 to 50 nm after drying. For application, silicone having a reactive functional group may be diluted with a solvent. A diluting solvent is not particularly limited, but examples thereof include alcohols. A dilution concentration is not particularly limited, but is preferably 1 to 5 wt %, and more preferably 1 to 3 wt %.

The adhesive layer is preferably formed by applying the adhesive on the second cellulose-based film 231 and on one or both sides of the second polarizer 50. After the second cellulose-based film 23′ and the second polarizer 50 are attached together, the whole is preferably subjected to drying step to form an adhesive layer formed of the applied and dried layer. The adhesive layer may be formed and then attached. The second cellulose-based film 23′ and the second polarizer 50 may be attached by using a roll laminator or the like. A heat drying temperature and a drying time may appropriately be determined in accordance with the type of adhesive.

The adhesive layer has a thickness of preferably 0.01 to 10 μm, and more preferably 0.03 to 5 μm because too large a thickness after drying is not preferred from the viewpoint of adhesive property with the second cellulose-based film 23′.

The second cellulose-based film 23′ and the second polarizer 50 may further include a pressure-sensitive adhesive layer as at least one outermost layer (preferably, on the second cellulose-based film 23′ side). The pressure-sensitive adhesive layer is provided to bond with other members of other optical films, liquid crystal cells, or the like.

The same pressure-sensitive adhesive as that described in the above section E may be employed as the pressure-sensitive adhesive forming the pressure-sensitive adhesive layer and for the method of providing the pressure-sensitive adhesive layer.

An anchor layer may be provided between the optical film (the second cellulose-based film 23′, for example) and the pressure-sensitive adhesive layer for improving the adhesive property therebetween.

The same anchor layer as that described in the above section E may be employed as the anchor layer.

In the present invention, the second polarizer 50, the second cellulose-based film 23′, the adhesive layer, the pressure-sensitive adhesive layer, and the like may each have UV absorbing ability by being treated with a UV absorber such as a salicylate-based compound, a benzophenol-based compound, a benzotriazole-based compound, a cyano acrylate-based compound, or a nickel complex-based compound.

Hereinafter, the present invention will be described more specifically by way of examples. However, the present invention is not limited to the examples. Methods of measuring properties in examples are described below.

<Measurement of Retardation>

Refractive indices nx, ny, and nz of a sample film were measured by using an automatic birefringence analyzer “KOBRA-21ADH” (manufactured by Oji Scientific Instruments), to thereby calculate an in-plane retardation Re and a thickness direction retardation Rth. A measurement temperature was 23° C., and a measurement wavelength was 590 nm. Note that the in-plane retardation Re and the thickness direction retardation Rth measured at a measurement wavelength of 590 nm may be represented by Re(590) and Rth(590), respectively.

<Measurement of Color Shift>

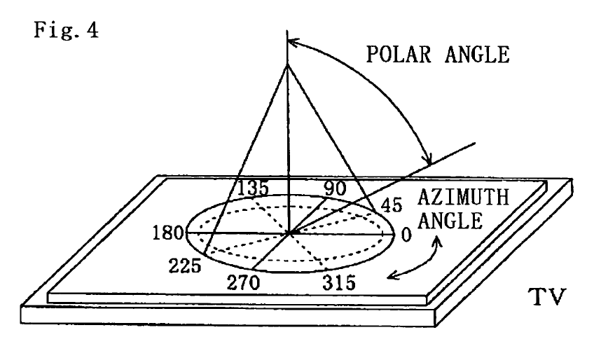

Color tones of a liquid crystal display apparatus were measured at an azimuth angle of 45° and a polar angle varying from 0 to 70°, or at a polar angle of 60° and an azimuth angle varying from 0 to 360° by using “EZ Contrast 160D” (trade name, manufactured by ELDIM SA), and were plotted on an XY chromaticity diagram. FIG. 4 shows the azimuth angle and the polar angle.

<Measurement of Contrast Ratio>

A white image (absorption axes of polarizers are parallel to each other) and a black image (absorption axes of polarizers are perpendicular to each other) were displayed on a liquid crystal display apparatus produced, and were scanned from 45° to 135° with respect to the absorption axis of the polarizer on a viewer side and from −60° to 60° with respect to the normal by using “EZ Contrast 160D” (trade name, manufactured by ELDIM SA). A contrast ratio “YW/YB” in an oblique direction was calculated from a Y value (YW) of the white image and a Y value (YB) of the black image.

### REFERENCE EXAMPLE 1

### Production of Cellulose-Based Film (1)

Cyclopentanone was applied to polyethylene terephthalate, and the whole was attached to a triacetyl cellulose film having a thickness of 40 μm (“UZ-TAC”, trade name, available from Fuji Photo Film Co., Ltd., Re(590)=3 nm, Rth(590)=40 nm). The resultant was dried at 100° C. for 5 minutes, and the polyethylene terephthalate film was peeled off after drying. The obtained cellulose-based film (1) had Re(590) of 0.2 nm and Rth(590) of 5.4 nm.

### REFERENCE EXAMPLE 2

### Production of Cellulose-Based Film (2)

A norbornene-based resin was dissolved in cyclopentanone, to thereby prepare a solution containing 20 wt % of a solid content. This solution was applied to a triacetyl cellulose film having a thickness of 40 μm (“UZ-TAC”, trade name, available from Fuji Photo Film Co., Ltd., Re(590)=3 nm, Rth(590)=40 nm) to a thickness of 150 μm. The resultant was dried at 140° C. for 3 minutes, and the norbornene-based resin film formed on a surface of the triacetyl cellulose film was peeled off after drying. The obtained cellulose-based film (2) had Re(590) of 1.1 nm and Rth(590) of 3.4 nm.

### REFERENCE EXAMPLE 3

### Production of Cellulose-Based Film (3)

A solution was prepared by dissolving 18 parts by weight of dibutyl phthalate as a plasticizer with respect to 100 parts by weight of aliphatic acid cellulose ester having a degree of acetic acid substitution of 2.2 and a degree of propionic acid substitution of 0.7 in 570 parts by weight of acetone as a solvent. This solution was applied to a stainless steel plate through a general flow casting method, dried, and peeled off from the stainless steel plate, to thereby obtain a cellulose-based film (3) having a thickness of 80 μm. The obtained cellulose-based film (3) had Re(590) of 3.1 nm and Rth(590) of 3.1 nm. The degree of substitution of the aliphatic acid cellulose ester was measured in accordance with ASTM-D-817-91 (Methods of Testing Cellulose Acetate and the like).

### REFERENCE EXAMPLE 4

### Production of Cellulose-Based Film (4)

A solution was prepared by dissolving a mixture of a triacetyl cellulose resin (degree of acetic acid substitution of 2.7) and p-toluenesulfonanilide as a plasticizer in a ratio (weight ratio) of 88:12 in methylene chloride. This solution was applied to a stainless steel plate through a general flow casting method, dried, and peeled off from the stainless steel plate, to thereby obtain a cellulose-based film (4) having a thickness of 80 μm. The obtained cellulose-based film (4) had Re(590) of 0.5 nm and Rth(590) of 1.1 nm.

### REFERENCE EXAMPLE 5

### Production of Polarizer

A polyvinyl alcohol film was colored in an aqueous solution containing iodine, and the resultant was uniaxially stretched to a six times length between rolls with different speed ratios in an aqueous solution containing boric acid, to thereby produce a polarizer.

### REFERENCE EXAMPLE 6

### Preparation of Polyvinyl Alcohol-Based Adhesive

An aqueous solution of a polyvinyl alcohol-based adhesive was prepared by adjusting to a concentration of 0.5 wt % an aqueous solution containing 20 parts by weight of methylol melamine with respect to 100 parts by weight (degree of acetylation of 13%) of a polyvinyl alcohol resin subjected to acetoacetyl modification.

### EXAMPLE 1

(Production of Laminate (A1) Having Optical Compensation Layer Formed on Cellulose-Based Film (1))

Polyimide synthesized from 2,2-bis(3,4-dicarboxyphenyl)hexafluoropropane dianhydride (6FDA) and 2,2′-bis(trifluoromethyl)-4,4′-diaminobiphenyl (TFMB) and having a weight average molecular weight (Mw) of 70,000 was dissolved in methyl isobutyl ketone, to thereby prepare a 15 mass % polyimide solution. Preparation of polyimide and the like were preformed through the method described in the document (F. Li et al., Polymer 40 (1999) 4571-4583).

The polyimide solution was applied to the cellulose-based film (1) obtained in Reference Example 1, and the whole was dried at 100° C. for 10 minutes. Next, the resultant was subjected to 5% longitudinal uniaxial stretching at 160° C., to thereby obtain an optical compensation layer formed on the cellulose-based film (1). The optical compensation layer had a thickness of 55 μm. The optical compensation layer had an in-plane retardation Re(590) of 60 nm, a thickness direction retardation Rth(590) of 250 nm, and an Nz coefficient of 4.2. The optical compensation layer had optical properties of nx>ny>nz. 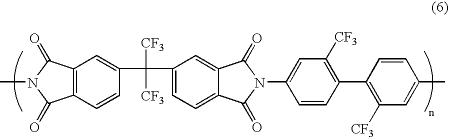
(Production of Optical Film (1))

The polarizer obtained in Reference Example 5 was laminated on the cellulose-based film (1) side of the laminate A by using the polyvinyl alcohol-based adhesive (thickness of the adhesive layer of 50 nm) obtained in Reference Example 6. The lamination was performed such that the slow axis of the optical compensation layer and the absorption axis of the polarizer were substantially perpendicular to each other. A commercially available TAC film (“PF80UL”, trade name, available from Fuji Photo Film Co., Ltd., thickness of 80 μm) as a transparent protective layer was laminated on a side of the polarizer without the cellulose-based film (1) laminated through a polyvinyl alcohol-based adhesive (thickness of the adhesive layer of 50 nm), to thereby obtain an optical film (1).

(Production of Optical Film (2))

The polarizer obtained in Reference Example 5 was laminated on the cellulose-based film (1) side obtained in Reference Example 1 by using the polyvinyl alcohol-based adhesive (thickness of the adhesive layer of 50 nm) obtained in Reference Example 6. A commercially available TAC film (“PF80UL”, trade name, available from Fuji Photo Film Co., Ltd., thickness of 80 μm) as a transparent protective layer was laminated on a side of the polarizer without the cellulose-based film (1) laminated through a polyvinyl alcohol-based adhesive (thickness of the adhesive layer of 50 nm), to thereby obtain an optical film (2).

(Production of Liquid Crystal Panel)

A liquid crystal cell was removed from a 26-inch liquid crystal monitor “Aquos 26-inch (LC-26GD1)” manufactured by Sharp Corporation, and the optical film (1) was attached on a backlight side of the liquid crystal cell (that is, a side opposite to color filters with respect to the liquid crystal layer) such that the TAC protective layer was arranged on an outer side (backlight side) through an acrylic pressure-sensitive adhesive (thickness of 20 μm). The optical film (2) was attached to a viewer side of the liquid crystal cell such that the TAC protective layer was arranged on an outer side (viewer side). In this way, a liquid crystal panel (1) was produced.

(Evaluation)

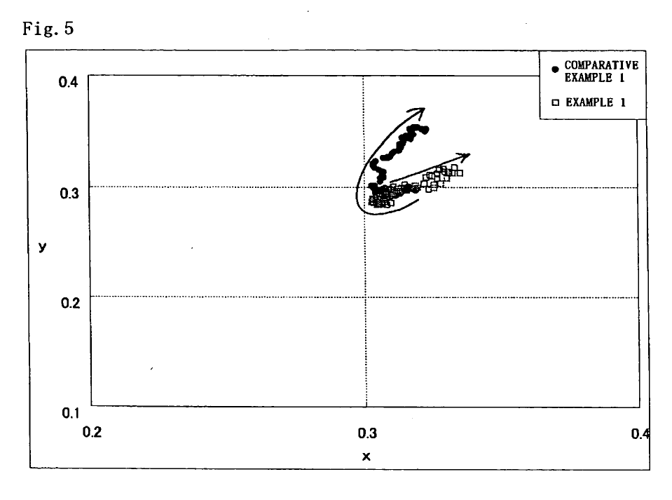

Color shift of the obtained liquid crystal panel (1) was measured at an azimuth angle of 45° and a polar angle varying from 0 to 70°. FIG. 5 shows the results.

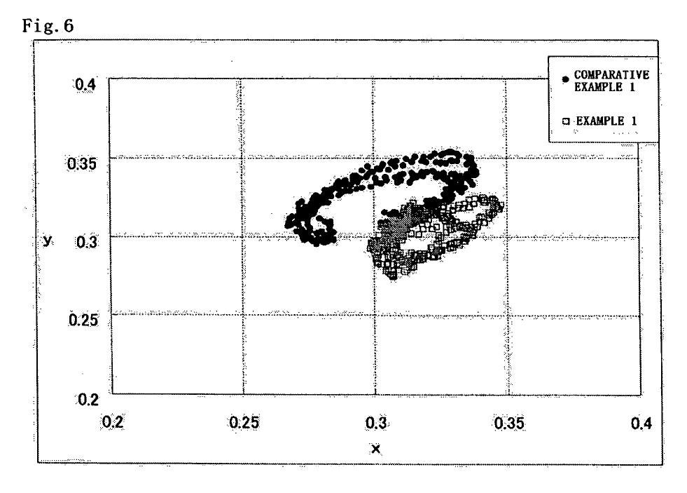

Color shift of the obtained liquid crystal panel (1) was measured at a polar angle of 60° and an azimuth angle varying from 0 to 360°. FIG. 6 shows the results.

Contrast ratios of the obtained liquid crystal panel (1) were measured at a polar angle of 60° and an azimuth angle of 45°, 135°, 225°, and 315°. Table 1 shows the results.

### COMPARATIVE EXAMPLE 1

(Production of Liquid Crystal Panel)

A liquid crystal panel (C1) was produced in the same manner as in Example 1 except that a triacetyl cellulose film having a thickness of 40 μm (“UZ-TAC”, trade name, available from Fuji Photo Film Co., Ltd., Re(590)=3 nm, Rth(590)=40 nm) was used instead of the cellulose-based film (1) used in Example 1.

(Evaluation)

Color shift of the obtained liquid crystal panel (C1) was measured at an azimuth angle of 45° and a polar angle varying from 0 to 70°. FIG. 5 shows the results.

Color shift of the obtained liquid crystal panel (C1) was measured at a polar angle of 60° and an azimuth angle varying from 0 to 360°. FIG. 6 shows the results.

Contrast ratios of the obtained liquid crystal panel (C1) were measured at a polar angle of 60° and an azimuth angle of 45°, 135°, 225°, and 315°. Table 1 shows the results.

TABLE 1

Contrast ratio

Azimuth angle

| | 45° | 135° | 225° | 315° | Average |
|---|---|---|---|---|---|
| Example 1 | 39 | 36 | 31 | 38 | 36 |
| Comparative | 29 | 30 | 30 | 34 | 31 |
| Example 1 | | | | | |

### EXAMPLES 2 TO 4

(Production of Liquid Crystal Panel)

Liquid crystal panels (2) to (4) were each produced in the same manner as in Example 1 except that the cellulose-based films (2) to (4) obtained in Reference Examples 2 to 4 were used instead of the cellulose-based film (1) used in Example 1.

(Evaluation)

Color shift of each of the obtained liquid crystal panels (2) to (4) at an azimuth angle of 45° and a polar angle varying from 0 to 70°, color shift of each of the obtained liquid crystal panels (2) to (4) at a polar angle of 60° and an azimuth angle varying from 0 to 360°, and contrast ratios of each of the obtained liquid crystal panels (2) to (4) at a polar angle of 60° and an azimuth angle of 45°, 135°, 225°, and 315° were measured. The results were similar to those of Example 1.

FIGS. 5 and 6 reveal that the liquid crystal panel (1) obtained in Example 1 had much better color shift than that of the liquid crystal panel (C1) obtained in Comparative Example 1. For example, FIG. 5 shows that the color shift moves in a V-shape in Comparative Example 1, indicating a large color shift to a human eye, in particular. FIG. 6 shows that the color shift in Comparative Example 1 moves more than the color shift in Example 1.

Table 1 shows that contrast ratios from an oblique direction of Example 1 are larger than those of Comparative Example 1.

The liquid crystal panel of the present invention and the liquid crystal display apparatus including the liquid crystal panel may suitably be used for a liquid crystal television, a cellular phone, or the like.

What is claimed is:

1. A liquid crystal panel comprising: a first polarizer; a first cellulose-based film; an optical compensation layer having an Nz coefficient represented by an equation (1) of 2≦Nz≦20; a liquid crystal cell; a second cellulose-based film; and a second polarizer in the order given from a backlight side to a viewer side, wherein:
the first cellulose-based film has a thickness direction retardation (Rth) represented by an equation (2) of 10 nm or less; and
the second cellulose-based film has a thickness direction retardation (Rth) represented by the equation (2) of 10 nm or less.
Nz=(nx−nz)/(nx−ny) (1)
Rth=(nx−nz)×d (2)

2. A liquid crystal panel according to claim 1, wherein the first cellulose-based film has a thickness direction retardation (Rth) of 6 nm or less.

3. A liquid crystal panel according to claim 1, wherein the first cellulose-based film comprises an aliphatic acid-substituted cellulose-based polymer.

4. A liquid crystal panel according to claim 3, wherein the aliphatic acid-substituted cellulose-based polymer has a degree of acetic acid substitution of 1.8 to 2.7.

5. A liquid crystal panel according to claim 3, wherein the aliphatic acid-substituted cellulose-based polymer has a degree of propionic acid substitution of 0.1 to 1.

6. A liquid crystal panel according to claim 3, wherein the first cellulose-based film comprises at least one plasticizer selected from the group consisting of dibutyl phthalate, p-toluenesulfonanilide, and acetyl triethyl citrate.

7. A liquid crystal panel according to claim 6, wherein a content of the plasticizer is 40 parts by weight or less with respect to 100 parts by weight of the aliphatic acid-substituted cellulose-based polymer.

8. A liquid crystal panel according to claim 1, wherein the second cellulose-based film has a thickness direction retardation (Rth) of 6 nm or less.

9. A liquid crystal panel according to claim 1, wherein the second cellulose-based film comprises an aliphatic acid-substituted cellulose-based polymer.

10. A liquid crystal panel according to claim 9, wherein the aliphatic acid-substituted cellulose-based polymer has a degree of acetic acid substitution of 1.8 to 2.7.

11. A liquid crystal panel according to claim 9, wherein the aliphatic acid-substituted cellulose-based polymer has a degree of propionic acid substitution of 0.1 to 1.

12. A liquid crystal panel according to claim 9, wherein the second cellulose-based film comprises at least one plasticizer selected from the group consisting of dibutyl phthalate, p-toluenesulfonanilide, and acetyl triethyl citrate.

13. A liquid crystal panel according to claim 12, wherein a content of the plasticizer is 40 parts by weight or less with respect to 100 parts by weight of the aliphatic acid-substituted cellulose-based polymer.

14. A liquid crystal panel according to claim 1, wherein the optical compensation layer has a refractive index profile of nx>ny>nz.

15. A liquid crystal panel according to claim 1, wherein the optical compensation layer is formed of at least one non-liquid crystalline material selected from the group consisting of polyamide, polyimide, polyester, polyetherketone, polyamideimide, and polyesterimide.

16. A liquid crystal panel according to claim 1, wherein a slow axis of the optical compensation layer and an absorption axis of the first polarizer are substantially perpendicular to each other.

17. A liquid crystal panel according to claim 1, wherein the liquid crystal cell is of one of VA mode and OCB mode.

18. A liquid crystal display apparatus comprising the liquid crystal panel according to claim 1.
